(19) United States
(12) Patent Application Publication
(10) Pub. No.: US 2021/0039547 A1
(43) Pub. Date: Feb. 11, 2021

(54) CONTAINER FOR A SYSTEM FOR DISTRIBUTING GOODS IN URBAN AREAS

(71) Applicant: VINCI CONSTRUCTION, Rueil-Malmaison (FR)

(72) Inventors: Jerome Stubler, Paris (FR); Maxime Trocme, Paris (FR); Jean-Serge Boissavit, Paris (FR)

(21) Appl. No.: 16/978,056

(22) PCT Filed: Mar. 1, 2019
(86) PCT No.: PCT/EP2019/055227

§ 371 Date: Sep. 3, 2020

(30) Foreign Application Priority Data
Mar. 5, 2018 (FR) 1851865

(51) Int. Cl. B60P 7/13; B61B 13/10; B65D 90/00; B61D 3/20

(52) U.S. Cl. CPC B60P 7/13; B61D 3/20; B65D 90/006; B61B 13/10

(57) ABSTRACT

A container, in particular for a system for distributing goods in urban areas. The system includes at least one micro-tunnel forming at least one transport loop, a greatest inside dimension of the micro-tunnel in cross section, in particular its inside diameter, preferably being between 1.5 m and 4 m inclusive, shuttles circulating in the micro-tunnel, a plurality of stations for exchange with the surface, enabling raising of the goods, the container being a fork-liftable, and having a base with inside dimensions adapted to receive only one or at most two pallets.

The present invention concerns the distribution of goods in urban areas.

At present goods are conveyed in towns mainly with the aid of vehicles such as trucks, which gives rise to multiple problems.

Firstly, the great majority of these vehicles being internal combustion engine vehicles, their circulation contributes to the air pollution in the towns. Then the delay in distributing goods is found to be lengthened because of the congestion of the roads.

Consequently there exists a need to facilitate and to accelerate the distribution of goods in urban areas, in particular in dense urban areas.

A system for automated conveyance of goods has been proposed in the application CN 105046474, including a looped pipeline with a certain number of branches. The pipeline is equipped with rails that serve to supply electrical energy to the vehicles that circulate therein.

The patent application US 2002/0062759 discloses an automated transport system of point to point type including multiple autonomous containers moving on rails in tunnels disposed for example at a shallow depth under dwellings or on the surface. Each container can be moved by an electric motor. A system of this kind is not designed to transport a high volume of goods and is not suitable for servicing an entire conurbation, with a daily tonnage of goods typically of several hundreds or even thousands of tons. Moreover, the container circulation paths have to be installed in conjunction with the layout of the dwellings they pass, because at least some of the paths are disposed at the same depth as the cellars of those dwellings. The containers are of varied size and the rails are suitable for the circulation of different sizes of containers, which multiplies the number of rails and renders the system relatively complex and costly to install. Moreover, recovering the goods inside the containers may prove complicated because the containers are not designed to leave their rails.

The application FR 2 847 873 proposes an integrated system for conveying goods in towns via the metro. The containers are transported by vehicles that are loaded onto cars. A system of this kind presupposes the existence of a metro the tunnels of which would be sufficiently large to receive the cars loaded with the vehicles on which the containers rest, and would prove very difficult to implement in most towns.

The invention aims to improve further goods distribution systems in order to address the problem of distributing goods in town centers.

### GOODS DISTRIBUTION SYSTEM

Thus, in accordance with a first of its aspects, the invention consists in a system for distributing goods in urban areas, including:

at least one micro-tunnel forming at least one transport loop,

shuttles circulating, in particular unidirectionally, in the micro-tunnel,

a set of containers the external dimensions of which are suitable for their transportation by the shuttles, and having an interior volume adapted to receive goods packaged on pallets to the standard format,

a plurality of stations for exchange with the surface, enabling raising of the containers.

The invention addresses the problem of the logistics of the penultimate kilometer in dense urban areas by enabling the burying of the transport loop at a relatively great depth. A depth of this kind avoids, or even minimizes, interference with existing buildings. The invention also enables reduction of urban pollution.

The choice of a micro-tunnel to produce the transport loop enables proven techniques to be employed and the buried system to be produced at a cost compatible with the economic stakes.

The containers are advantageously fork-liftable containers. The use of fork-liftable containers facilitates handling them and their dimensions makes it possible to avoid repackaging goods already packaged on pallets.

Moreover, the format of the containers offers multiple possibilities of arranging their interior volume and distributing the associated goods. The size of the containers can easily be standardized, which reduces their unit cost and facilitates the construction and the automation of the systems intended to manipulate them.

The shuttles advantageously circulate unidirectionally along the loop. Each section between two exchange stations of the loop has therefore passed through it goods that circulate in the same direction as the direction of that section. Thus the shuttles do not pass each other in the micro-tunnel, which enables the section of the micro-tunnel to be adapted closely to the section of a loaded shuttle and reduction of the section of the micro-tunnel not useful for the transportation of the goods. Nevertheless, the invention does not rule out the goods being conveyed in the loop with the aid of at least one line where the goods onboard shuttles would circulate bidirectionally. That line could have two tracks in a tunnel or two parallel tunnels, as explained hereinafter.

### SCHEDULING STATIONS

The transport system preferably includes at least one station for scheduling the goods to be injected into the loop and to be distributed via the exchange stations situated on the loop. The scheduling station enables the goods runs to be prepared in order in particular for the goods combined in the same container to correspond to a delivery arriving at the same exchange station, at which the container will be removed from the loop formed by the micro-tunnel and raised to the surface, to be taken over by a fleet of electric vehicles for example, that will convey these goods to their final destination. The scheduling station may concentrate the logistical means for packaging the goods and loading the containers. This station can handle most or even all of the loading of the shuttles, the exchange stations in the loop preferably having a main role of distributing goods rather than a role of loading them.

The transport system may include at least one so-called “penetrating” line for feeding the loop with goods. This line may be unidirectional or not.

The presence of one or more scheduling stations at the periphery of the system and of the town serviced by the loop enables a high flow of goods to be managed and a large quantity of goods to be injected into the loop, more easily than the exchange stations situated on the loop itself could do, communicating with shafts that can be relatively narrow.

Moreover, the line may have a slope and the scheduling station may be buried, where its underground installations are concerned, at a lesser depth than the depth at which the sections of the micro-tunnel forming the loop are buried.

### EXCHANGE STATIONS

The exchange stations may be configured to transport a plurality of containers simultaneously to the surface or to the micro-tunnel.

An exchange station may be connected to only one upstream loop section and one downstream loop section external to the station. There may be a turn in the station, without having to reverse the direction of progress of the goods, from the upstream section to the downstream section.

At least one exchange station may be adapted to store containers, in particular pending collection of the transported goods at the surface, storage taking place for example in the corresponding shafts or alternatively at the surface or in a cellar. Storing at least some of the containers in the shafts of the exchange stations or in the buried spaces fed by the exchange stations makes it possible to minimize the footprint of the system. The containers are preferably produced so as to be stackable vertically. Alternatively, they are stored on racks.

The shaft of at least one of the exchange stations is preferably of sufficient size to serve as a working shaft during the digging of the micro-tunnel by a micro-tunneling technique. This enables the excavation works carried out when digging the micro-tunnel to favor the subsequent production of one or more exchange stations and using the latter to store goods or equipment.

The system may include at the level of the exchange stations an automated shuttle unloading and/or loading system. In particular, the system may include surface transport vehicles adapted to transport the containers, or the goods conveyed by the latter. In particular, the delivery of the goods in the final kilometer may be handled by a fleet of electric vehicles. The transport vehicles may have a platform to receive the containers.

Each exchange station may include a roller device for example for progressively decelerating the shuttles upon their arrival at the exchange station and a launching device to enable them to lock onto the moving cable without too severe a jerk.

The exchange station may include a mechanism for recovering goods conveyed by a shuttle, in particular by removing the container or containers transported by the shuttle, whilst allowing the shuttle then to continue its path in the transport loop.

A shuttle may be unloaded by changing the shuttle track or by extracting its content without changing track.

The exchange station includes for example a mechanism for transporting a track portion carrying a shuttle between a first position receiving a new shuttle arriving from the transport loop, in which the track portion is situated in continuity with the track extending in the micro-tunnel, and a second position, of passage on a loading/unloading track, which allows one or more containers transported by the shuttle to be offloaded toward an elevator such as a service elevator or to the shuttle to receive one or more new containers to be transported.

Alternatively, only the shuttle is moved from the arrival track to the loading/unloading track, without its movement being accompanied by movement of the rails on which its wheels are engaged.

As a further alternative, the containers are offloaded from the shuttle without switching it onto a specific loading/unloading track.

The shuttles may be driven by any means when they are not coupled to the drive cables, for example by rollers or by any other auxiliary drive mechanism.

The containers may be transported by roller conveyors and/or by a transporter bridge or a pallet truck.

The loop may include turns that are situated at the level of the exchange stations. This can make it possible to retain rectilinear sections in the loop, which facilitates the construction of the micro-tunnel and the driving of the shuttles. To have the shuttles take turns, they may be retained on rails and a turntable provided including a mobile rail track that enables them to be oriented toward the departing track. They could furthermore not be retained on rails, being driven with the aid of an auxiliary driving system in which they are for example carried by rollers or by a roller conveyors or conveyed by another conveyor system enabling the shuttles to execute tight turns.

In one embodiment, while the exchange station connects two sections of the micro-tunnel forming the loop that are oriented in different directions with a non-zero angle between them, the exchange station includes a turntable carrying a mobile track portion on which at least one shuttle can be positioned.

This turntable is able to assume a position in which the mobile track comes into alignment with a shuttle feeding track and a position in which said mobile track comes into alignment with the track of the next section of micro-tunnel to be passed through.

A further object of the invention is an exchange station including a buried part connecting two sections of micro-tunnel and including means for unloading shuttles circulating in the micro-tunnel.

The exchange station includes for example a first track mobile between a position to receive a shuttle coming from one of the sections and a position for switching the shuttle onto a loading/unloading track, on which the shuttle passes in front of a system for conveying containers toward and away from an elevator to the surface and a second track mobile between a position to receive the shuttle circulating on the loading/unloading track and a position for switching it to the other section.

The exchange station may be adapted to cause the goods that are circulating in the loop to execute a turn.

In one example the exchange station may include a mobile track mounted on a turntable if the two sections of micro-tunnel disposed upstream and downstream of the station are at an angle to one another. Alternatively, the exchange station includes means for conveying shuttles without rails, for example on rollers or castors, enabling the required turn to be executed. The use of means for conveying the shuttles without rails or mobile tracks facilitates the movement of the shuttles and avoids the use of switches. This enables the use of shuttles that are not self-propelled. This also enables a saving in terms of compactness, and therefore of limiting the volume of soil to be excavated to construct the exchange station. The use of a turntable greatly facilitates connecting sections of micro-tunnel at a large angle to one another and enables the sections to be oriented in such a manner as to optimize their length. This also enables use of rectilinear sections, compatible with the use of a cable system for pulling the shuttles and enabling a high speed of circulation of the shuttles.

### SHUTTLES

The shuttles transporting the containers may be self-propelled shuttles but are preferably shuttles pulled by cables. The use of cables enables the cost of the shuttles to be reduced whilst providing a rapid and reliable transport system.

Each traction cable may circulate between two ends of a section of the loop formed by the micro-tunnel, those ends preferably being situated at the level of stations for exchange with the surface. When they travel in the loop formed by the micro-tunnel, the shuttles can therefore move from a first loop section in which they are moved by a first cable to a second loop section where they are moved by a second cable different from the first, the transfer from the first section to the second taking place in an exchange station.

The micro-tunnel may be equipped with rails on which the shuttles move.

The cable disposed in a section may be more than 1 km long, for example at least 4 km, better still 6 km, for example 8 km or more long, which then enables the production of a section 4 km or more long since the cable circulates in one direction pulling the shuttles and in the other with no load. The cable may be mounted on pulleys and tensioning rollers in a manner analogous to the systems used in ski lifts and chair lifts.

The cable may move between the rails, parallel thereto, which enables a saving in terms of compactness, and where necessary mounting of the structure guiding the cable on a support shared with the rails.

The shuttles may each include a platform to receive at least one container. This platform may be sized to receive four, six or eight containers disposed in two rows of two, three or four containers, each container being adapted to receive a standard pallet, in particular a pallet, a half-pallet or a quarter-pallet of ISO type (also known as an American or universal pallet), EPAL/EUR type (also known as a European pallet), CP or VMF type. Alternatively, the cradle may be adapted to receive two, three or four double containers, each double container being adapted to receive two standard pallets disposed side by side inside the double container.

Each shuttle may include front and rear partitions between which the container or containers to be transported are disposed.

Alternatively, the shuttles have no front and rear partitions.

If necessary the underground system according to the invention for distributing goods is equipped with a system for regulation of the transport of the containers without flow management general intelligence, each transport shuttle being fitted with one or more sensors for locating a preceding shuttle and the exchange stations, enabling the shuttles to regulate their speed as a function of the traffic, to stop at the exchange stations and possibly to push a broken down shuttle to move it out of the loop of the micro-tunnel. In a regulation system of this kind each container may carry an electronic device that exchanges data with the shuttle and enables it for example to tell the destination of the goods present in the container.

A further object of the invention is a shuttle for transporting at least one container according to the invention, including a mechanism for coupling it to a drive cable, wheels, and a space to receive the container or containers, preferably four, six or eight containers disposed in two rows of two, three or four containers. The shuttle may be open at the sides and include or not include front and rear partitions.

A further object of the invention is a combination consisting of a container and a shuttle for transporting the container in a micro-tunnel, the shuttle including a platform to receive the container to which the latter is removably attached.

### MICRO-TUNNEL

The micro-tunnel preferably has a cross section of circular general shape.

The micro-tunnel may be produced in various ways and for example include sections assembled one after the other, in particular between 2.5 and 3.5 m inclusive long with a wall thickness between 150 and 500 mm inclusive, these sections preferably being adapted to receive a driving thrust of at least 500 tons.

Alternatively, the micro-tunnel includes assembled segments.

The sections or segments are preferably made at least in part of reinforced concrete, in particular with a double layer of reinforcing bars.

The micro-tunnel may include a lining, in particular a metal lining.

In one embodiment, a greatest inside dimension of the micro-tunnel in cross section, in particular its inside diameter, is between 1.5 m and 4 m inclusive, in particular between 1.5 and 2.5 m inclusive or between 2.5 m and 4 m inclusive, for example between 1.5 and 2.2 m inclusive or between 3 and 4 m inclusive. For example, the inside diameter of the micro-tunnel is 3.3 m+/−0.1 m.

The micro-tunnel is advantageously buried at a depth greater than or equal to 5 m. The use of a micro-tunnel in the invention enables a greater burying depth to be employed, for example greater than 20 m or 30 m, or even greater than 35 m, 40 m or 50 m or more, so as to pass widely under existing foundations and infrastructures and not to interfere with them. The penetrating line may be buried at a depth that varies and is not that of the loop.

The micro-tunnel may be under reduced oxygen pressure. This makes it possible to limit the risk of fire. In particular, the oxygen level may be 15%, better 20% or 50%, or more, below the nominal level in the open air.

The loop formed by the micro-tunnel may include a succession of sections the length of which is for example greater than 1 km, connected by exchange stations that make the connection between the sections with different orientations. The sections may be rectilinear if required, as mentioned hereinabove, which can facilitate excavation and construction of the micro-tunnel.

### CONTAINERS

In accordance with one aspect of the invention the containers used in the distribution system according to the invention are fork-liftable containers.

By “fork-liftable container” is meant a container that has at its base passages enabling the insertion therein of the forks of a pallet truck so as to lift it and move it using the pallet truck. These passages may be produced between blocks and where appropriate reinforced with metal profiles or tubes.

The container may include at its base front to rear and/or lateral through-passages for the passage of the forks of a pallet truck and be fork-liftable from front to rear and/or laterally.

The container preferably includes at its base passages through it from front to rear and laterally for the passage of the forks of a pallet truck and is fork-liftable from front to rear and laterally. Each of the four sides of the base of the container may therefore be fork-liftable, in particular the shorter sides of the base, which enables manipulation of the container to be facilitated. The containers may be manipulated from a shorter side, if necessary, for example during loading or unloading a shuttle.

A single container is adapted to receive a standard pallet.

A standard pallet is a pallet with dimensions defined by the ISO 6780 standard or a EUROPE pallet, in particular an EUR, EUR 1, EUR 2, EUR 3 or EUR 6 pallet.

The pallet may have dimensions of 1016*1219 mm, 1000*1200 mm, 1165*1165 mm, 1067*1067 mm, 1100*1100 mm or 800*1200 mm. The pallet is preferably a EUROPE pallet 800 by 1200 mm.

The internal section (in cm2) of the single container may have dimensions (X+dx)·(Y+dy), where X and Y are the dimensions of the sides of the pallet intended to be received in the container and dx is between 1 and 20 cm inclusive, better between 5 and 20 cm inclusive, better between 5 and 15 cm inclusive, even better between 7.5 and 12.5 cm inclusive, and/or dy is between 1 and 20 cm inclusive, preferably between 5 and 20 cm inclusive, better between 5 and 15 cm inclusive, even better between 7.5 and 12.5 cm inclusive.

A double container is adapted to receive two standard pallets disposed side by side, preferably with their longer sides adjacent.

The interior section (in cm²) of the double container may be (2X+dx)·(Y+dy), or (X+dx)·(2Y+dy), where dx is between 1 and 20 cm inclusive, preferably between 5 and 20 cm inclusive, better between 5 and 15 cm inclusive, even better between 7.5 and 12.5 cm inclusive, and/or dy is between 1 and 20 cm inclusive, preferably between 5 and 20 cm inclusive, better between 5 and 15 cm inclusive, even better between 7.5 and 12.5 cm inclusive.

The interior volume of the single or double container is preferably between 100 and 220 cm inclusive.

The outside dimensions of the container enable it to circulate on the shuttles and to reach the surface easily using the means provided to this end in the exchange stations, such as elevators.

The outside dimensions W and D of the container preferably satisfy W<150 cm, better W<140 cm, preferably with 125 cm<W<130 cm, better W=130 cm, where W designates the width of the container, and D<100 cm for a container intended to receive a single EUROPE pallet, better 85 cm<D<95 cm, better D=90 cm, where D designates the depth of the container.

The opening of the container, that is to say the front of the container, may be adapted to receive the longer side of the pallet.

If the container is intended to receive two EUROPE pallets side by side, preferably 175 cm<D<185 cm, better D=180 cm, the width W being preferably the same as for the container intended to receive a single pallet.

The height H of the single or double pallet is preferably less than 240 cm, better less than 230 cm, even better less than 220 cm, being preferably equal to 210 cm. In particular, the height may be between 100 and 220 cm inclusive.

It is advantageous for the size of the container to be as small as possible beyond a nominal internal volume in order to reduce the section of the tunnel and the cost of building it.

Independent of or in combination with what is disclosed above, a further object of the invention is therefore a container, in particular for a system for distributing goods in urban areas as defined above, that system including:

at least one micro-tunnel forming at least one transport loop, a greatest inside dimension of the micro-tunnel in cross section, in particular its inside diameter, being preferably between 1.5 m and 4 m inclusive.

shuttles circulating in the micro-tunnel,

a plurality of stations for exchange with the surface, enabling lifting of the goods,

the container being a fork-liftable container,

preferably with no refrigeration unit, and

having a base with inside dimensions preferably adapted to receive only one pallet or at most two pallets. That pallet or those pallets are received placed flat on the base of the container.

By “refrigeration unit” must be understood a unit generating cold from an electrical power supply, including a compressor and a motor driving that compressor.

The container is preferably made so that its interior volume can be entirely closed at least during transportation of the goods. Alternatively, the container is not closed at the front.

As mentioned above, the container may have an interior section adapted to receive a single pallet, in particular an interior section X+dx by Y+dy, where X and Y designate the dimensions of the sides of the pallet received in the container, with dx between 1 and 20 cm inclusive and dy between 1 and 20 cm inclusive, the pallet preferably being chosen from standard EUROPE pallets, preferably of EUR, EUR 1, EUR 2, EUR 3 or ISO type as defined in the standard ISO 6780, even better of EUROPE 80 cm by 120 cm type.

The container may have an interior section adapted to receive only two pallets disposed side by side, preferably having an interior section 2X+dx by Y+dy, or X+dx by 2Y+dy, where X and Y designate the dimensions of the sides of the pallets received in the container, with dx between 1 and 20 cm inclusive and dy between 1 and 20 cm inclusive, the pallets preferably being chosen from standard EUROPE pallets, preferably of EUR, EUR 1, EUR 2, EUR 3 or ISO type as defined in the standard ISO 6780, even better of EUROPE 80 cm by 120 cm type.

The container may include a base, lateral walls, a rear wall, a top wall, and a door at the front. The container may be made of metal.

The front door is preferably a double door, each panel including a plurality of articulated flaps. This makes it possible to minimize the overall size of the door when the latter is open and thus to be able to position the open containers close together, which minimizes the footprint. The door may be produced otherwise, for example include a roller shutter, two single panels or only one panel, or alternatively replaced by one or more removable bars or a chain. Thus the container may have an opening with no door through across which at least one bar or one chain may be mounted.

It may be advantageous for at least one of the containers to have independent compartments that can be opened and closed independently of one another.

This may in particular be of benefit from the logistical point of view by allowing access to only a part of the container to recover the corresponding goods, while the goods present in the other compartments remain inaccessible. This may be useful if those receiving the goods vary and the goods are taken at different times by different operatives.

A further object of the invention is a container according to the invention and a standard pallet disposed inside it. That pallet may be a single pallet, the container being a single container.

A further object of the invention is a container according to the invention and two standard pallets disposed one behind the other inside it. Those two pallets may be the only ones, the container being a double container.

### MECHANISM FOR ATTACHING CONTAINERS TO SHUTTLES OR SURFACE VEHICLES

The shuttles and containers are preferably adapted so that the containers can be locked into place by an appropriate locking mechanism.

That mechanism is compatible with automated loading and unloading of the shuttles and/or the vehicles.

Independently of or in combination with what is disclosed above, a further object of the invention is a container including at least one first attachment means intended to cooperate with at least one second attachment means present on a platform intended to receive the container, in particular a platform of a shuttle or of a surface vehicle, to enable its immobilization on said platform.

The first attachment means and the second attachment means may be configured to engage automatically upon placing the container on the platform.

The first attachment means may include at least one hook carried by the container, adapted to hook onto the second attachment means.

The first attachment means may include at least one relief onto which may be hooked a hook of the second attachment means, in particular a relief formed by or in a passage intended to receive a fork of a pallet truck.

The second attachment means may include a mechanism transforming a push exerted on a bearing member when placing the container on the platform into a movement, in particular rotation, of a hook coming to be engaged on the first attachment means, the latter preferably including a bar on which said hook is engaged at the end of its movement.

The first attachment means may include two lateral flanges and the second attachment means rollers under which the lateral flanges are engaged upon placing the container on the platform.

The second attachment means may include a lock mobile vertically and the first attachment means include a housing to receive that lock.

The platform may include rollers enabling the container to roll on it.

In one embodiment the shuttles are equipped with locks that come to engage with the passages provided on the base of the containers for the forks of the pallet trucks. Thus the containers may be locked with no additional cost at the level of the containers since the structure of the base of the containers has not been modified.

In variants, the containers are adapted to receive locks that engage over specific reliefs produced elsewhere than at the level of the passages for the forks of the pallet trucks.

In other embodiments, the containers are equipped with locks adapted to hook over corresponding reliefs provided on the shuttles.

The locks can be unlocked, for example with the aid of electromagnetic actuators.

There are for example four locks provided per container.

The mechanism for locking the containers on the shuttles is preferably the same as that used to lock the containers onto the surface vehicles.

There may also be produced on the surface areas for storage of the containers including bases to receive containers equipped with the same locking means.

Independent of or in combination with what is disclosed above, a further object of the invention is a combination including:

at least one container including said first attachment means,

a shuttle or a surface vehicle including said second attachment means.

### MEANS FOR CENTERING PALLETS IN THE CONTAINERS

Each container intended to receive a pallet preferably includes a means for centering that pallet inside the container.

A centering means of this kind is advantageous in the context of automated loading and unloading of the containers because it improves the accuracy of positioning the pallets in the containers and facilitates this automation.

This centering means preferably includes one or more guides positioned at the periphery of the bottom of the container.

The centering means may include a ramp extending over all the perimeter of the bottom except for two openings at the front of the container for the passage of the forks of the pallet truck.

The height of the ramp is for example between 1 and 20 cm. The dimensions of the ramp are chosen to leave on the bottom of the container just the room for the pallet. Thus the pallet is guided by the ramp when it is placed in the container. The width of the ramp may be between 1 and 4 cm for example.

The ramp may be formed of one or more elements mounted on the bottom of the container, made of metal or thermoplastic material for example. The ramp may be made in one piece with the bottom of the container, for example by pressing or casting.

Where appropriate the ramp may house an electronic device and/or a sensor.

Independent of or in combination with what is disclosed above, an object of the invention is therefore a container including a base and a means for centering a pallet, that centering means having openings for the passage of the forks of a pallet truck.

### COMPARTMENTALIZATION OF THE CONTAINER

Independently of or in combination with what is disclosed above, a further object of the invention is a container including:

a base,

lateral walls, in particular corrugated vertically or horizontally,

retractable supports fixed to the lateral walls, enabling at least one pallet to be disposed at a height in the container or inserts, boxes or drawers to be disposed, enabling compartmentalization of the container.

By “vertically corrugated lateral wall” is meant a lateral wall having a corrugated surface the generatrix of which is oriented vertically.

By “horizontally corrugated lateral wall” is meant a lateral wall having a corrugated surface the generatrix of which is oriented horizontally.

The lateral walls may be corrugated vertically or horizontally. The corrugations are for strengthening the lateral walls, in particular for greater stiffness. This enables a stronger container to be obtained.

A plurality of compartments may be created in the container by disposing at least one additional bottom at a certain height from the base.

Profiles may for example be disposed on the lateral walls on which a board is placed at the required height. These profiles are for example riveted to the lateral walls if the latter are made of metal.

The container may therefore include a plurality of profiles ready at different heights.

The lateral walls of the container may further be provided with retractable supports able to assume a position folded against the wall and a deployed position serving to support a pallet or a bottom board placed on top.

These retractable supports include for example lugs articulated on a support fixed to the wall, able to assume two stable positions, namely one position in which the lug is stowed against the wall and the other in which the lug extends for example obliquely upward to serve as a support. The lateral wall of the container may be ribbed and in the deployed position the lug may bear against a flank of a rib, which immobilizes it.

The containers may be without specific thermal insulation and with no refrigeration unit. The containers may further be adapted to transport refrigerated goods.

### CONTAINER FOR REFRIGERATED GOODS

Independent of or in combination with what is disclosed above, another object of the invention is a container including at least one, preferably removable, box made of a thermally insulating material disposed inside the container, in particular with dimensions adapted for it to be inserted with no clearance or with a small lateral clearance in the container, this box preferably being a fork-liftable box.

By “small clearance” is meant a clearance sufficient to enable the insertion of the box but insufficient for the box to be able to move excessively afterwards. The clearance is for example 1 cm or less between the wall of the box and the facing wall of the container, better less than 0.5 cm, or even less than 0.2 cm.

The container can therefore receive one or more boxes made of a thermally insulating material, for example expanded polystyrene.

These boxes may have dimensions adapted to the interior volume of the container and be fork-liftable boxes or not. These boxes may include a removable front cover that enables their content to be offloaded without removing the box from the container.

The use of boxes adapted to the interior dimensions of a container enables simple manufacture at lower cost of an isothermal container suitable for transporting foodstuff goods. The box may be easily replaced if necessary, if it is damaged.

### CONTAINER WITH INTEGRAL BAG

Independent of or in combination with what is disclosed above, a further object of the invention is a container including:

a bag disposed in the container so as to assume a folded state during the transportation of goods in the container and a deployed state enabling the transportation of empty packaging, the bag being preferably suspended from slides disposed inside the container, this bag preferably having a front panel that can be opened and closed with the aid of a closure device.

The goods transported in the containers may include cardboard cartons and other packaging that the receivers of the goods wish to dispose of

This packaging may be returned with the aid of the containers.

The bag may be unfolded to receive the packaging.

The container may be adapted to enable the bag to be suspended whilst enabling its deployment from a goods transportation configuration in which the bag rests against one of the walls of the container to an active configuration in which the bag is deployed in the interior volume of the container.

The bag may be adapted to open at the front, thanks for example to a zip closure, which enables it to be emptied without detaching it from the container.

### CONTAINER WITH BIN

The container may be used to transport a bin containing for example waste such as debris, bulky refuse or waste to be recycled.

This bin may have dimensions suitable for the interior volume of the container, be a fork-liftable bin and include automatic means for raising and emptying it by tilting it. The bin may where appropriate include wheels.

The bin may where appropriate have a front opening for inserting waste; thus the container may be left open with the bin inside for the time for the latter to be filled via its front opening, after which the container is closed and transported out of the town via the micro-tunnel.

### CONNECTED CONTAINER

The container may include an electronic system for storing data and/or transmitting it to a receiver.

The container may be equipped with sensors providing information on the temperature and/or relative humidity in its interior volume.

The container may also include one or more sensors providing information on opening, movement and/or position of the door.

The data received may be stored by the container and/or transmitted remotely using an appropriate transmission protocol, for example of the Internet of objects type, such as SIGFOX, LORA, etc.

The container may receive a connected pallet, that is to say one that is provided with one or more sensors and/or transponders, and receive information from the pallet, or better exchange data with the latter. For example, the container may store an identifier of the pallet.

The container may exchange information with the shuttle or the surface vehicle that transports it and for example transmit automatically to that shuttle or that vehicle a destination for delivery of the goods contained in the interior.

### CONTAINER USED AS LOCKER

The container may be transported via the micro-tunnel, raised by an exchange station and conveyed to a place where it is left awaiting recovery of the goods by their recipient.

The container may be equipped with a door fitted with a connected lock opening of which can be remote controlled. Alternatively, the container receives a locker module provided with one or more connected doors, opening of which is remotely controllable.

Independently of or in combination with what is disclosed above, the invention further consists in a container including:

lateral, rear and top walls,

a fork-liftable locker module disposed inside the container, that locker module including at least one rack fitted with a door that can be unlocked remotely,

the module preferably including a plurality of racks each equipped with a door opening of which may be remote controlled.

### SET OF CONTAINERS

A further object of the invention is a set of containers for a system as defined above for distributing goods. That set of containers preferably includes a small number of sizes of containers, for example a single batch of single containers with a size adapted to receive a single standard pallet, preferably a EUROPE pallet 800 by 1200 mm, where appropriate with a plurality of different heights of those containers, and a set of accessories for modulating the occupation of those containers as a function of the various application and of the nature of the goods, such as inserts for example in the form of boards for compartmentalizing them, isothermal boxes, bins and/or locker modules.

This batch of containers and accessories may where appropriate be completed by double containers intended to receive two pallets, preferably EUROPE pallets.

A further object of the invention is a combination including a container according to the invention and a fork-liftable bin, preferably including a pivoting lid, possibly a front opening provided with a folding flap, and lifting means enabling it to be tilted to empty it.

### SURFACE VEHICLES

Once raised by an exchange station, a container may be loaded onto a dedicated vehicle for transporting it a short distance to its destination.

This vehicle is preferably a low-loader so that loaded with the container its height remains less than or equal to 2 m80.

This enables carparks and basements to be used as spaces for storing the containers and for loading the vehicles.

The vehicles may include a platform to receive one or more containers, loaded from the rear of the vehicle.

The vehicle is preferably compatible with automated loading and may include at the rear a retractable curtain that is raised after loading the vehicle. The platform of the vehicle may be provided with rollers enabling the container to be rolled into its final position on the platform. This makes it possible to dispense with the use of lifting means and further facilitates the conveying of the containers.

### GOODS DISTRIBUTION METHOD

In accordance with another of its aspects, invention further consists in a method for distributing goods in urban areas with the aid of a system according to the invention as defined above, including the steps consisting in:

a) using surface transport means to bring goods to an exchange or scheduling station,

b) disposing them in preferably fork-liftable containers,

c) lowering those containers to the micro-tunnel,

d) causing the containers to circulate in the micro-tunnel to another station for exchange with the surface,

e) raising the containers to the surface.

The method may also include the following additional steps:

f) unloading the containers or some or all of the goods that they contain,

g) delivering the containers to their recipients, either complete or in sub-sets pre-established when packing the containers.

The majority of the goods transported in the loop preferably come from at least one scheduling station adapted to handle high logistical flows and connected to the loop by a dedicated line, namely the penetrating line mentioned hereinabove.

The method may include the transportation of more than 1000 tons/day, or even more than 10 000 tons/day of goods.

The method may include the step consisting in transporting the containers on shuttles pulled by cables. The cable may circulate at a speed greater than or equal to 5 m/s, better greater than or equal to 7 m/s, for example of the order of 8 m/s or more. Each shuttle may be accelerated on its departure from an exchange station to reach the speed of the cable and progressively braked on arriving at the next exchange station. The shuttle may include a releasable clamp that comes to be clamped onto the cable.

The weight of each loaded container is preferably between 100 and 500 kg inclusive or even more, for example 1000 kg or more.

In one embodiment of the invention, the method includes the following steps, for a container equipped with a locker module or including a plurality of independent compartments that can be opened selectively:

loading goods into the locker module or into the compartments,

transporting the container to the micro-tunnel and in the micro-tunnel to an exchange station,

raising the container to the surface,

conveying it to a collection point or disposing it on a surface vehicle,

advising the recipient of the arrival of the container at the collection point or of the arrival of the vehicle at its destination,

enabling automated opening of the locker or of the compartment containing the goods to be recovered,

returning the container to the micro-tunnel and conveying it to a station where the container is loaded again with goods.

The method may further include the steps consisting in:

loading at least one container onto a low-loader vehicle the total height of which when the vehicle is loaded with the container is less than 2 m80.

In one embodiment of the method, the container may be conveyed, in particular by surface transport vehicles, to a point for recovery of the goods, the container including at least one rack equipped with a door unlocking of which can be remote controlled or accommodating a locker module including at least one rack equipped with a door unlocking of which can be remotely controlled, in particular with the aid of a cellphone.

The method may include the steps consisting in:

disposing the container on a platform of a shuttle, in particular in an automated manner, preferably using the passages of the container provided to receive the forks of a pallet truck or by causing the container to roll on rollers,

locking the container in position with the aid of the first and second attachment mean previously mentioned,

transporting the container via the transport loop to a station for exchange with the surface,

acting on at least one of the first and second attachment means and unlocking the container,

removing the container from the transport shuttle, in particular in an automated manner preferably using the passages of the container provided to receive the forks of a pallet truck or by causing it to roll on rollers,

conveying the container to a surface vehicle, in particular using an elevator and one or more conveyors, in particular roller conveyors and/or autonomous pallet trucks,

disposing the container on a platform of the surface vehicle, in particular in an automated manner, preferably using the passages of the container provided to receive the forks of a pallet truck or by causing it to roll on rollers,

locking the container in position with the aid of the first and second attachment means.

The method can include the steps consisting in:

a) transporting the container in an urban area on a surface vehicle,

b) taking out goods contained in the container without lowering it from the surface vehicle or unlocking the container from the platform,

c) repeating steps a) and b) or returning the empty container to a surface station.

If the container must be delivered to a certain destination, the container may be unlocked automatically from the platform when the vehicle arrives at the destination.

An electronic circuit, in particular an RFID chip, may be carried on the container and exchange information with the surface vehicle, in particular to transmit to it a destination of the goods and/or to enable the vehicle to identify the container automatically, thereafter accessing a database to determine the destination of the goods.

When the container includes:

a bag disposed in the container in such a manner as to assume a folded state during the transportation of goods in the container and a deployed state enabling the transportation of empty packaging, the bag preferably being suspended from slides disposed inside the container, this bag preferably having a front panel that can be opened and closed with the aid of a closure device,

the method may include the step consisting in taking out goods present in the container and once the container is empty of its goods deploying the bag, loading the bag with empty packaging, in particular the packaging of goods previously transported using the container or an identical container, then returning the container loaded with the packaging to an exchange station and transporting the container with the aid of the transport loop to a station where it is recovered, emptied of the packaging present in the bag and reused, the bag preferably being folded in the container.

Independently of or in combination with what is disclosed above, a further object of the invention is a shuttle for transporting at least one container, in particular a container as defined above, including a chassis carrying at least two barriers defining between them at least one and better still two spaces each to receive one or more containers, that space or those spaces being open laterally, those barriers preferably including slides for guiding the container or containers in the receiving space or spaces, the ends of these slides preferably defining ramps for introduction of the container or containers into the receiving space or spaces, each barrier preferably including at least two top and bottom slides situated at different heights, the top slide preferably being disposed in such a manner as to be pressed onto the container above the mid-height of the latter. The aforementioned barriers enable compartmentalization of the shuttle whilst enabling easy loading and unloading of the containers from at least one of the sides of the shuttle.

The chassis may include two longitudinal members and a plurality of crossmembers that extend transversely to the longitudinal members between the latter, said barriers being preferably superposed vertically with respective crossmembers. For example, the barriers are fixed directly to the crossmembers.

The chassis may include a peripheral frame, preferably of rectangular shape, preferably formed of two longitudinal members and two front and rear crossmembers that extend transversely to the longitudinal members between the latter.

The shuttle may include front and rear axle assemblies, the peripheral frame preferably defining between the front crossmember and an adjacent crossmember a housing receiving the front axle assembly and between the rear crossmember and an adjacent crossmember a housing receiving the rear axle assembly.

Each axle assembly may include support wheels and lateral guide wheels, these wheels preferably being adapted to come to bear on vertical walls of the rails on which the support wheels roll. The guidance provided by the lateral guide wheels enables the use of support wheels of cylindrical shape, easy to produce and to maintain.

Each axle assembly may include a main arm and two lateral arches fixed to the ends of the main arm, the lateral arches being fixed at their ends to the chassis, in particular to the front and adjacent crossmembers for the front axle assembly and the rear and adjacent crossmembers for the rear axle assembly.

Each of the ends of the main arm may be divided into two branches fixed at their ends to the respective lateral arches.

The main arm of the front axle assembly can carry in its middle a mechanism for coupling it to the drive cable.

The cable coupling mechanism may be carried by a central arch fixed to the middle of the main arm and including a structure mobile relative to the central arch, that mobile structure including at least one upright that carries at least one roller for actuating the cable coupling mechanism, actuation of that roller driving vertical movement of the mobile structure, the coupling mechanism including at least two jaws connected by a transmission mechanism on the one hand to the fixed central arch and on the other hand to the mobile structure, this transmission mechanism being such that movement of the mobile structure relative to the fixed central arch is accompanied by clamping the jaws onto the cable or releasing the cable, depending on the upward or downward movement of the mobile structure, the mechanism preferably further including at least one elastic member for returning the jaws to the clamping position.

The support wheels may be mounted on yokes connected in an articulated manner to the middle of the lateral arches in such a manner as to be able to pivot about a vertical axis.

The guide wheels may be mounted on support structures connected in an articulated manner to the middle of the lateral arches so as to be able to pivot about a vertical axis.

The shuttle may include at least one container locking mechanism, that mechanism including two opposite rows of locking elements, those locking elements being able to assume a locking position in which they cooperate with the container or containers present in the associated receiving space so as to immobilize them in the latter, the locking elements of the same row being preferably articulated at their lower ends on a horizontal shaft so as to go by pivoting from a locking position to an unlocked position and vice versa. The locking elements may include lugs that engage over the containers at their base, to immobilize them in the receiving space.

The horizontal shaft of a row of locking elements may be connected to the locking elements of the opposite row so that within the same receiving space the actuation of one row of locking elements toward the locking position also drives movement of the locking elements of the opposite row toward the locking position, and vice versa. This limits the number of actuators necessary for driving the locking elements.

The locking elements of two adjacent receiving spaces, better of all the receiving spaces of the shuttle, may be adapted to be actuated by a single actuator, preferably an actuator external to the shuttle. This actuator is for example present at a station for exchange with the surface.

Actuation of the locking elements of one receiving space can drive the locking elements of an adjacent receiving space via one or more linkage mechanisms, that linkage mechanism being such that pivoting of the locking elements toward a locking position also drives the adjacent locking elements toward their locking position, and vice versa. This enables further reduction of the number of actuators needed.

The linkage mechanism may include two links connected at one of their ends to adjacent horizontal shafts and at the other of their ends to an elastic return member, in particular a coil spring, preferably oriented vertically, the linkage mechanism preferably being such that the elastic return member urges the locking elements toward the locking position.

The movement of the end of the links connected to the elastic return member may be guided vertically.

The horizontal shaft may carry rollers for actuating the locking mechanism adapted to cooperate with an actuator external to the shuttle.

The shuttle may include in each space for receiving one or more containers transport rollers oriented in the longitudinal direction of the shuttle, at least one of these rollers preferably being provided at one of its ends at least with a friction wheel configured to be driven in rotation by friction by a drive wheel external to the shuttle so as to drive this roller and preferably at least one other transport roller disposed in the receiving space in rotation about its axis via a transmission mechanism.

Independently of or in combination with what is disclosed above, a further object of the invention is a station for exchange with the surface or for scheduling goods, in particular goods contained in at least one container as defined above, including one or more actuators for actuating the locking elements of the shuttle, in particular the rollers for actuating the locking mechanism of the containers as defined above, and/or for driving in rotation the friction wheel or wheels as defined above, and/or for actuating the cable coupling mechanism as defined above.

Independently of or in combination with what is disclosed above, a further object of the invention is a micro-tunnel, in particular for a system for distributing goods in urban areas as defined above, including:

supports having a lower curvature face adapted for fixing them to a cylindrical section of the micro-tunnel,

rails carried by the upper face of the supports, the shuttles being adapted to roll on these rails, the latter preferably having vertical walls for the lateral guide wheels of the shuttles to roll on.

The support may carry a structure for guiding a shuttle drive cable.

The guide structure may include a lower roller on which rests a return section of the cable and an upper roller on which rests an outgoing section of the cable, with which the shuttles can be engaged to be driven on the rails, the two rollers preferably having parallel rotation axes and being sufficiently closely spaced vertically for the return section to come into contact with both the upper and lower rollers.

### DETAILED DESCRIPTION

The invention may be better understood after reading the following detailed description of nonlimiting embodiments thereof and examining the appended drawings, in which:

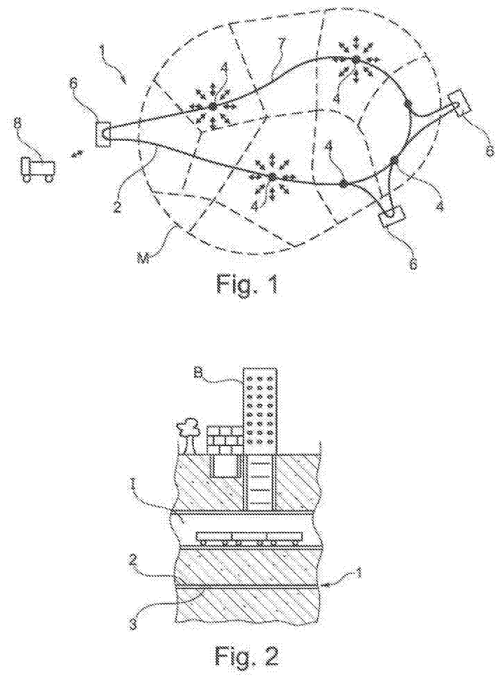

FIG. 1 represents very schematically a view from above of the path followed by the transport loop in one embodiment of the invention,

FIG. 2 is a vertical section of the system according to the invention in the town center,

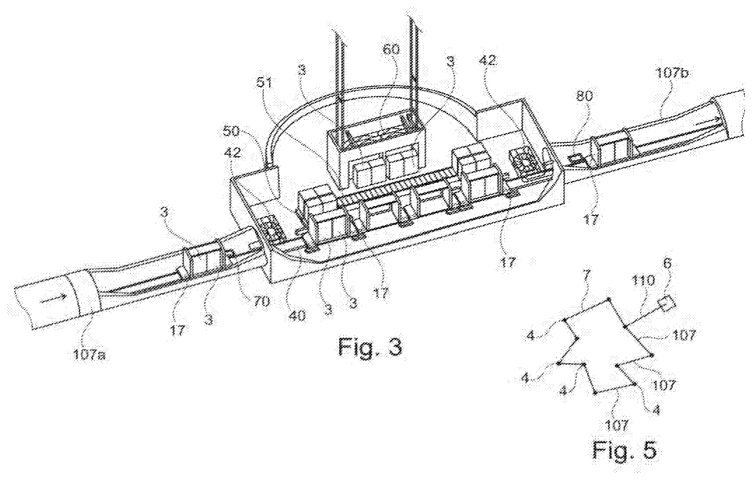

FIG. 3 represents schematically in perspective an example of an exchange station connecting two sections of the transport loop,

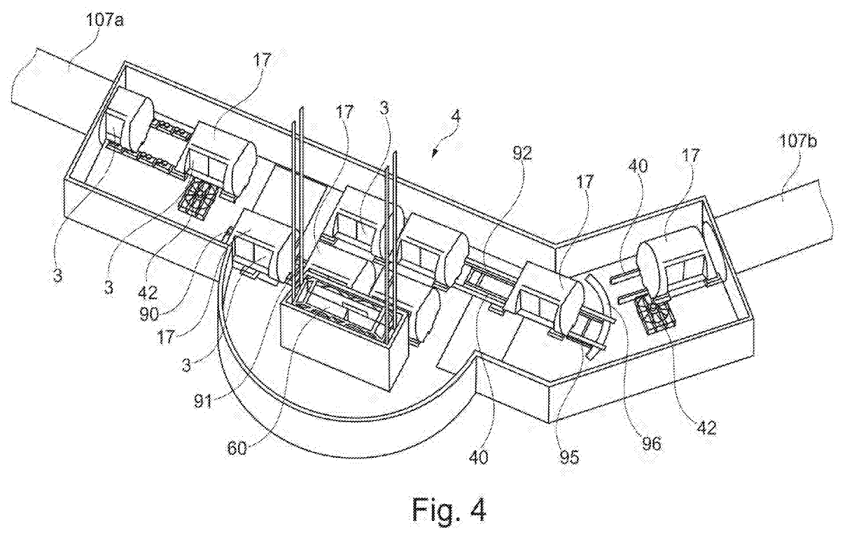

FIG. 4 represents a variant exchange station,

FIG. 5 represents schematically a variant transport loop,

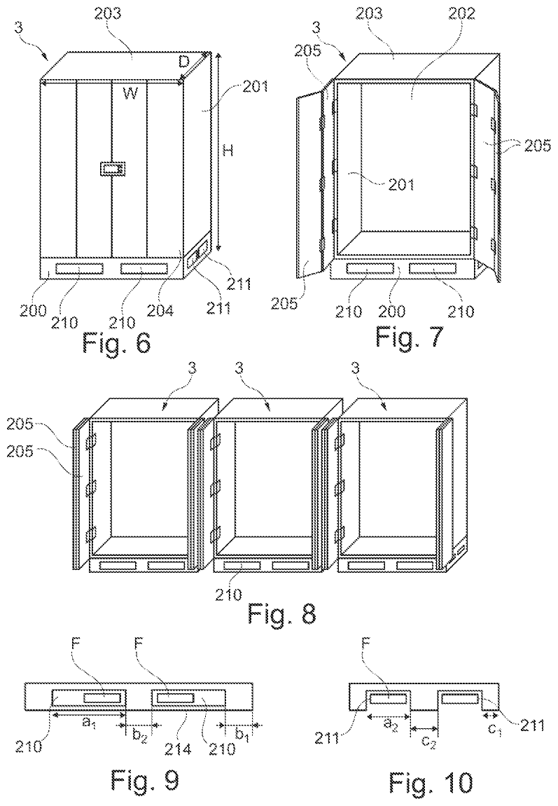

FIG. 6 represents an example of a container according to the invention when closed,

FIG. 7 represents the container from FIG. 7 when open,

FIG. 8 represents a plurality of open containers disposed side by side,

FIG. 9 represents separately the longer side of the base of the container,

FIG. 10 represents separately the shorter side of the base of the container,

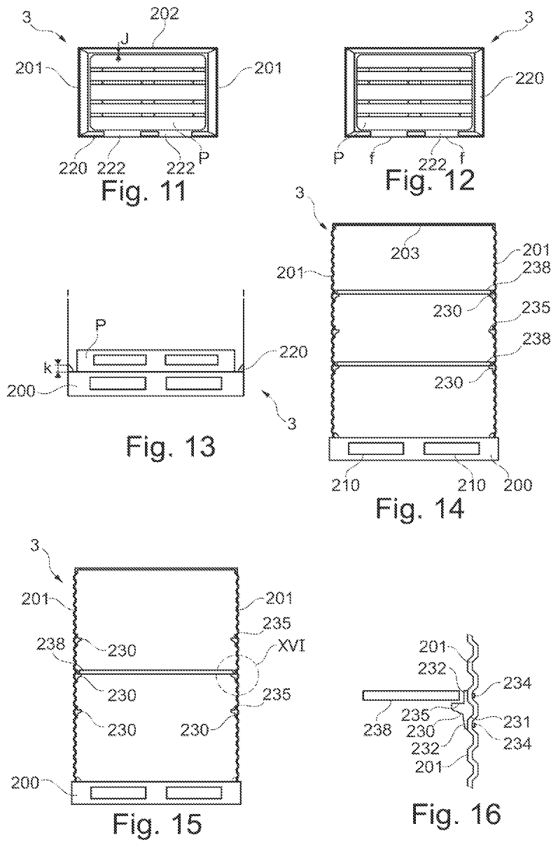

FIG. 11 represents the bottom of the container,

FIG. 12 illustrates the insertion of the forks of a pallet truck into the container,

FIG. 13 illustrates the centering of a pallet on the bottom of the container,

FIG. 14 represents a variant container offering a plurality of storage levels,

FIG. 15 is a view analogous to FIG. 14 with a different arrangement of the interior volume of the container,

FIG. 16 represents the detail XVI from FIG. 15,

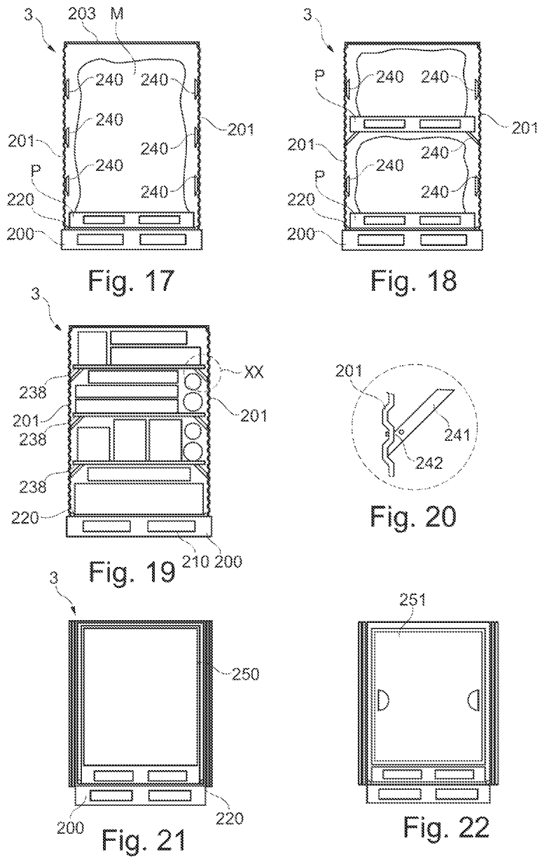

FIG. 17 represents a variant container,

FIGS. 18 and 19 illustrate the use of the container from FIG. 17 with loads on a plurality of levels,

FIG. 20 represents the detail XX from FIG. 19,

FIGS. 21 to 26, 28 and 29 represent different examples of packing refrigerated goods in a container,

FIG. 27 represents a variant container,

FIGS. 30 to 32 illustrate variant container formats,

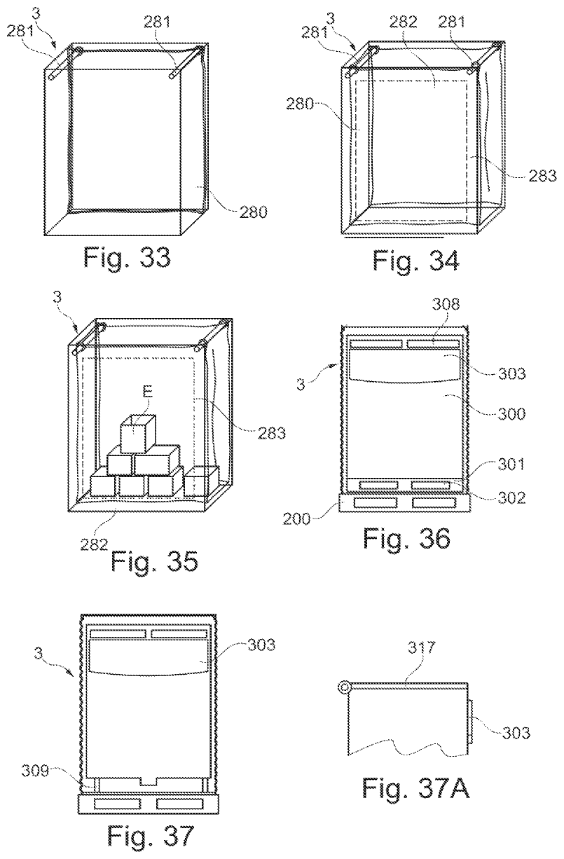

FIGS. 33 to 35 represent a variant container with integral bag,

FIG. 36 represents a container containing a fork-liftable bin for collecting waste,

FIG. 37 is an analogous view with a variant bin on wheels,

FIG. 37A represents a detail of the bin,

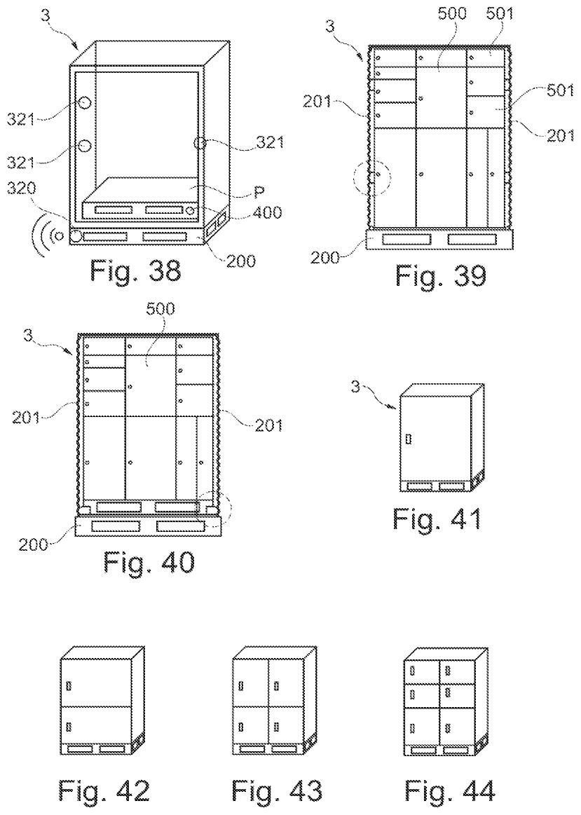

FIG. 38 represents a variant connected container,

FIGS. 39 and 40 represent variant containers with lockers,

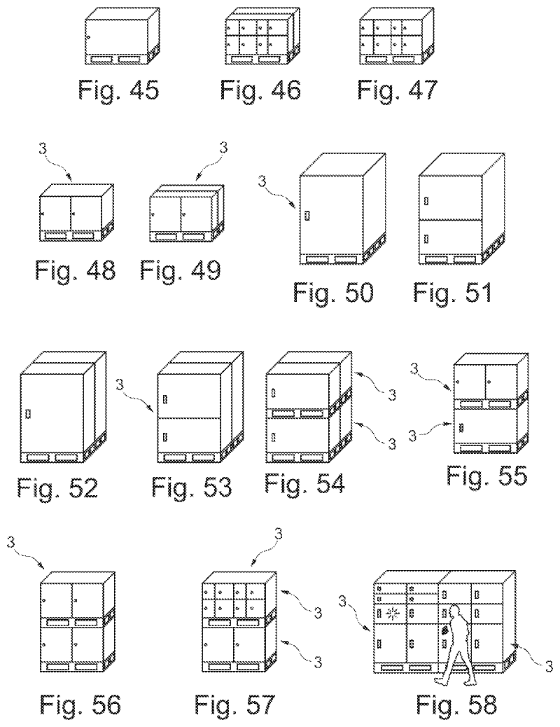

FIGS. 41 to 57 represent variant containers with lockers,

FIG. 58 illustrates the use of a locker container,

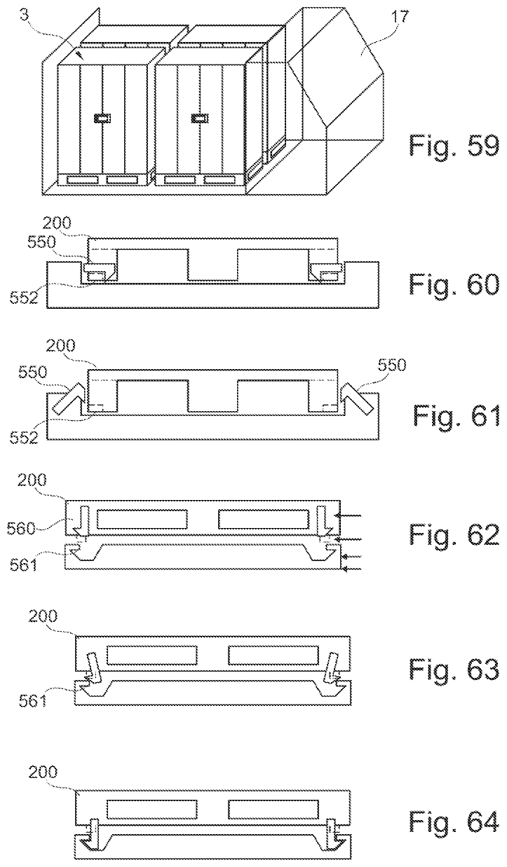

FIG. 59 represents partially and schematically a set of containers and a shuttle,

FIGS. 60 and 61 illustrate an example of locking the container onto the shuttle,

FIGS. 62 to 64 are views analogous to FIGS. 60 and 61 of variant ways of locking the container onto the shuttle,

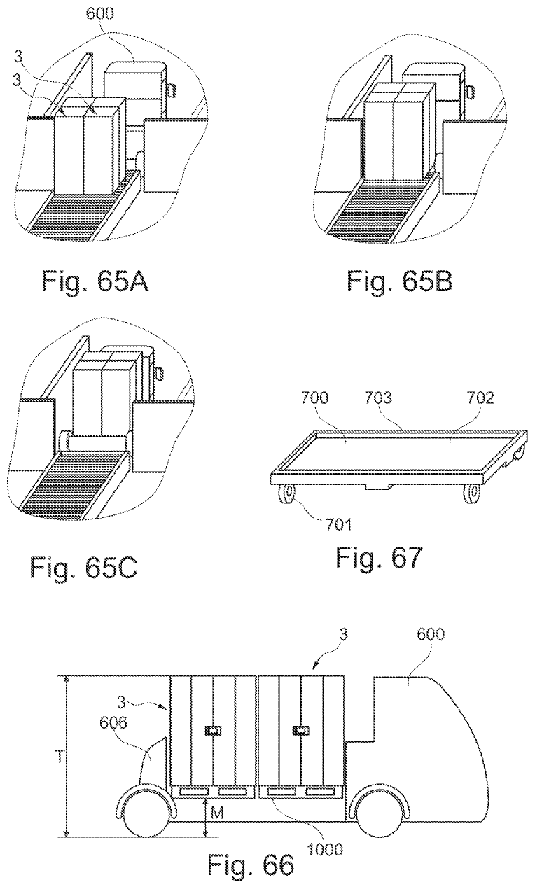

FIGS. 65A to 65C illustrate the loading of containers onto a surface vehicle,

FIG. 66 represents the surface vehicle,

FIG. 67 represents a trolley for handling a container according to the invention,

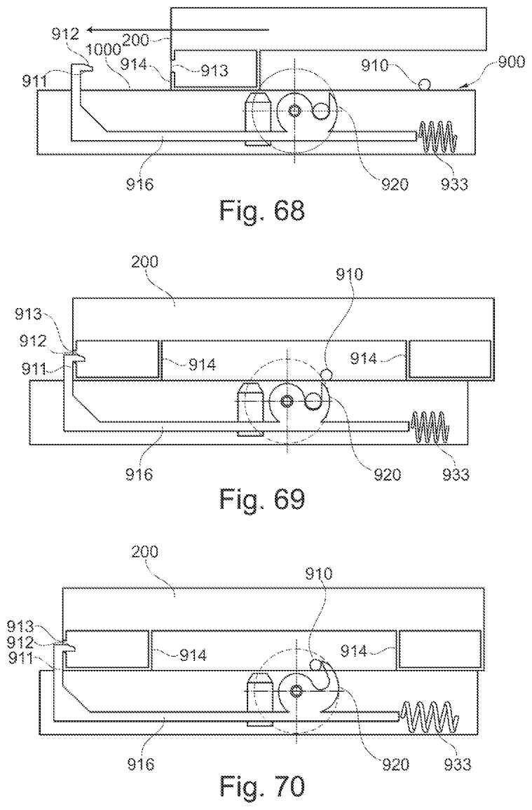

FIGS. 68 to 72 illustrate a variant mechanism for locking the container,

FIGS. 73 to 76 are views analogous to FIGS. 68 to 72 of another variant of the locking mechanism, FIG. 74 being a view on QXXIV in FIG. 75,

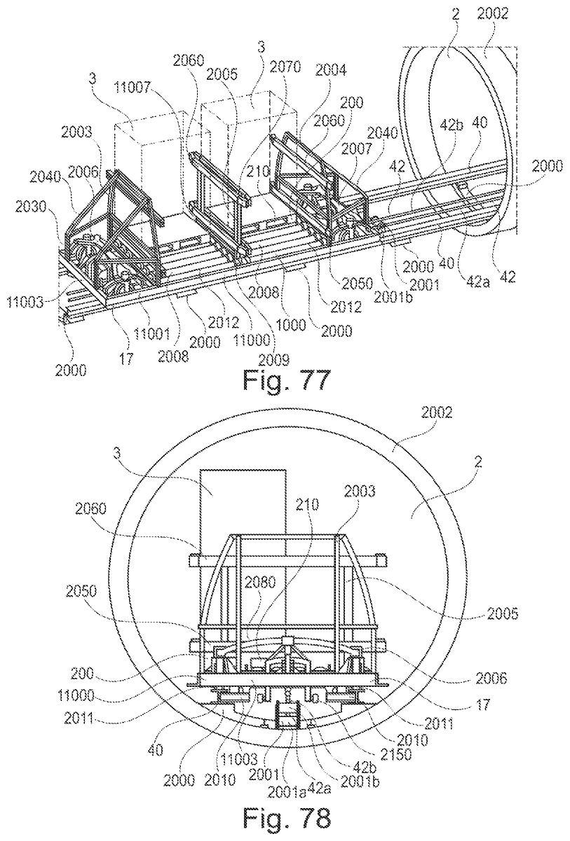

FIG. 77 represents an example of a shuttle and containers combination in a micro-tunnel,

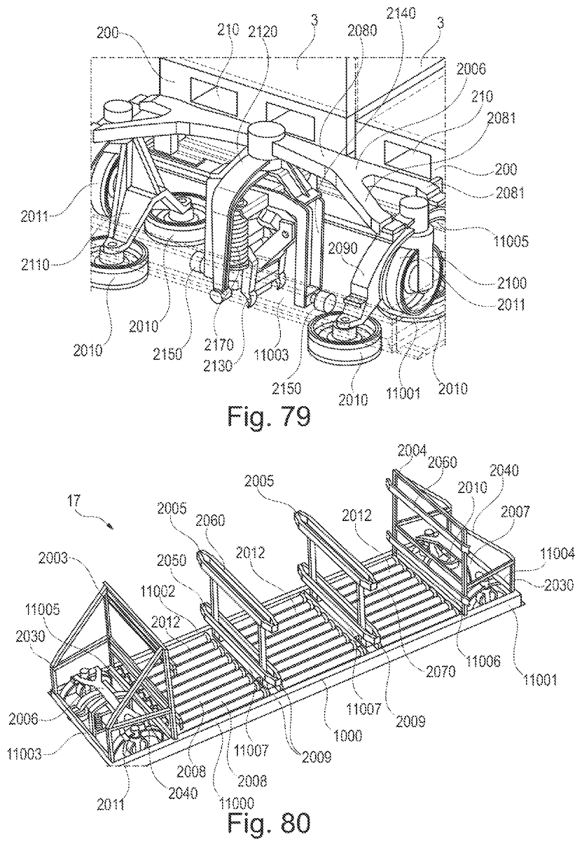

FIG. 78 represents in cross section an example of a combination of shuttle and containers in a micro-tunnel,

FIG. 79 represents an example of a front axle assembly of a shuttle,

FIG. 80 illustrates an example of a shuttle sized to receive six containers,

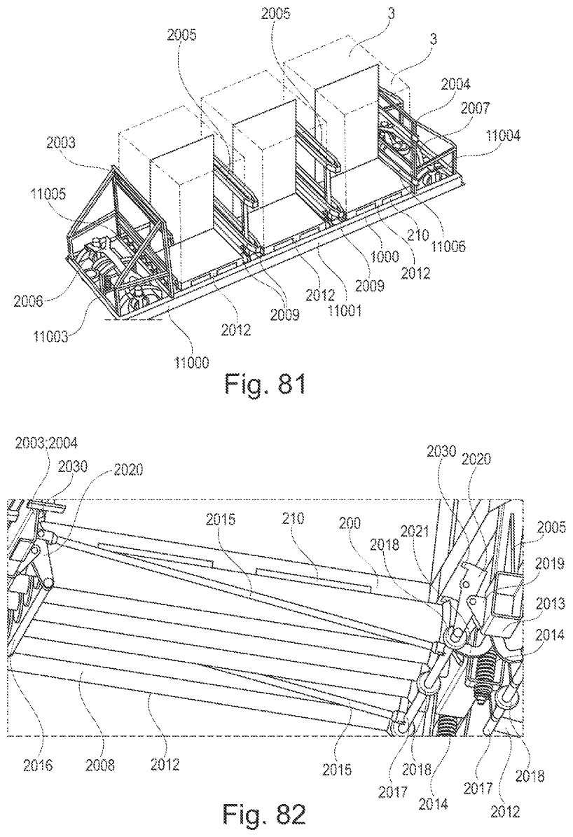

FIG. 81 represents an example of a combination of shuttle and containers, and

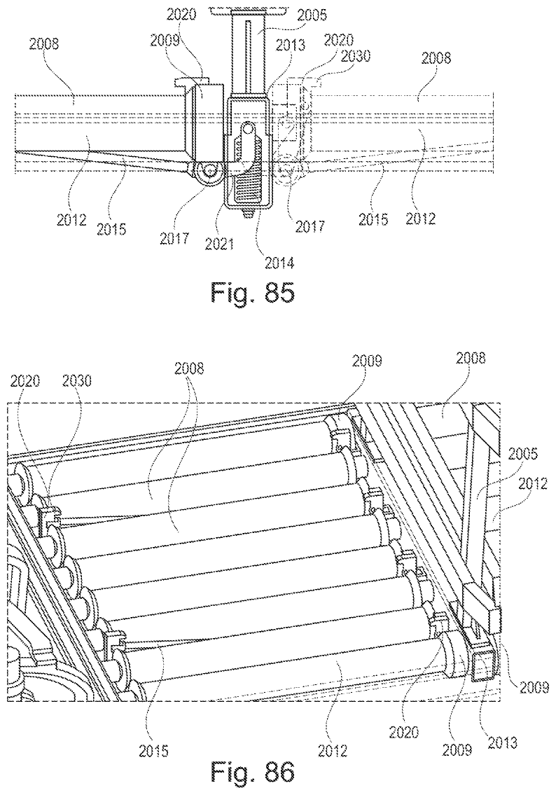

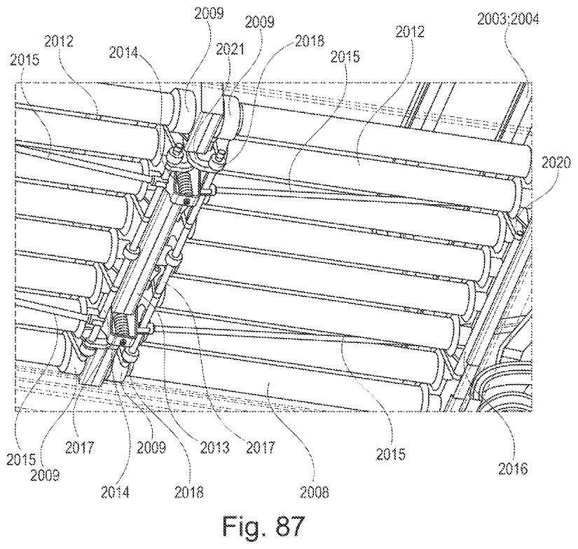

FIGS. 82 to 87 illustrate a variant mechanism for locking the containers, FIGS. 82, 83 and 87 being views from below, FIGS. 84 and 85 being side views, and FIG. 86 being a view from above.

System 1 according to the invention for distributing goods represented in FIG. 1 includes a micro-tunnel 2 that forms at least one transport loop 7 extending at least partly under a dense urban area M constituting a town center and including, as can be seen in FIG. 2, surface buildings B as well as underground structures I, under which the micro-tunnel 2 extends. The latter is adapted to enable the automated transport of goods present in containers.

The system 1 includes exchange stations 4 for lowering goods from and raising goods to the surface, these exchange stations 4 being disposed along the transport loop 7 in such a manner as to enable conveying of the goods in different zones Z of the town with a view to their local distribution.

The system 1 also includes stations 6 for scheduling the goods, which are provided outside the urban area M, at the periphery of the town, so as to facilitate the conveying and the departure of goods by surface transport means 8 such as trucks.

Each exchange station 4 includes a shaft in which extends a system for transporting containers between the surface or an underground warehouse and the micro-tunnel 2.

Referring to FIGS. 3 and 4, it can be seen that the containers 3 are carried by transport shuttles 17 that circulate unidirectionally in the micro-tunnel 2.

The containers 3 loaded with goods are brought by surface transport means 8 to at least one of the scheduling stations 6 situated at the periphery of or outside the town. The containers are then lowered to the micro-tunnel 2. Each container 3 is then transported to the exchange station 4 where at least some of the goods transported have to be delivered, and then raised to the surface. After those goods are removed, the container 3 is lowered again to the micro-tunnel 2 to continue its convey.

One or more elevators may be provided for raising and lowering the containers.

The containers are preferably stored in one or more surface warehouses or warehouses buried at a shallow depth.

In the FIG. 3 example the exchange station 4 connects a first section 107a of the transport loop 7 to a second section 107b that is aligned with the first in this example.

Cable drive mechanisms 42 are provided to move the shuttles 17 along the various sections 107 of the transport loop.

The shuttles 17 include a disengageable clamp device that comes to be clamped onto the transport cable in an analogous manner to the mechanisms present on disengageable ski lifts and chair lifts.

Devices 70 and 80 are respectively provided to produce progressive braking on arrival at the station 4 and progressive acceleration on departure from the station thanks to an auxiliary drive system.

In the FIG. 3 example the braking device 70 includes for example rollers that apply increasing friction to the shuttles 17 on their arrival in the vicinity of the station 4 so as to slow them down as far as the zone in which driving by the cable ceases. Each shuttle is then taken up by a conveyor means, for example by rollers that drive it past a system 50 for loading/unloading the containers 3.

This system 50 may include a roller conveyor 51 for transporting the containers 3 in front of the entry of an elevator 60 that enables them to be moved to the surface. The elevator may be a service elevator with two compartments, one used for example to recover the containers 3 offloaded by the shuttle 17 and the other to receive the containers 3 sent down from the surface and load them onto the shuttles 17, as shown.

The shuttles 17 then leave the station 4, being progressively accelerated by the device 80, which enables the shuttles 17 to reach the speed of the drive cable so as to be driven by the latter.

In the FIG. 4 variant the micro-tunnel sections 107a and 107b are at an angle to one another and the exchange station 4 includes a loading/unloading system. The shuttles that reach the exchange station 4 are successively positioned on a track section 90 mobile laterally between a first position in which the latter comes into alignment of the rails 40 of the upstream section 7a to receive the shuttles 17 and a second position as shown in FIG. 4 for unloading the shuttle 17 in which this mobile track section 90 comes into alignment with a loading/unloading track 91. That track 91 passes in front of an opening for transferring the containers 3 to an elevator 60 for raising/lowering them.

Once the containers 3 have been loaded on or unloaded from the shuttles 17 that pass in front of the elevator 60 with the aid of any appropriate transfer mechanism, the shuttles are positioned on a second mobile track section 92 that is movable laterally between a position enabling loading of the shuttles 17 that travel on the track 91 and a position in which that mobile section is aligned with a third track section 95 situated on a turntable 96. That turntable 96 enables recovery of the shuttle 17 previously positioned on the second mobile track section 92 and its rails may be placed in alignment with the track 40 of the downstream second section 107b in order for the shuttle 17 to depart on the latter.

A system of this kind for loading/unloading the shuttles 17 enables rapid and automated handling of the containers 3, compatible with driving by cables 42, and the presence of the mobile platform 96 facilitates the construction of the loop by enabling the use of rectilinear or substantially rectilinear loop sections 107.

In variants that are not shown the shuttles 17 are pivoted without a turntable by causing them to roll on castors or rollers and no longer on rails between the sections 107a and 107b, using guide means enabling a relatively tight turn to be executed where necessary.

In variants that are not shown the shuttles may also be moved to an unloading/loading track without transporting them simultaneously with the rails on which they are engaged, by moving them with the aid of a conveyor.

In a further variant the shuttles may be unloaded or loaded when they are on a track situated in continuity with tracks extending in the sections 107 of the micro-tunnel.

The micro-tunnel and the exchange stations are preferably under a reduced oxygen or inert atmosphere in order to reduce the risk of fire. This enables the cost of the infrastructure to be limited by making unnecessary certain safety devices that would otherwise have been imposed by the standards.

There has been represented in FIG. 5 a variant embodiment of the transport loop 7 including rectilinear or substantially rectilinear micro-tunnel sections 107 connected by the exchange stations 4, which are as shown in FIGS. 3 and 4 for example.

The main flow of goods injected into the loop 7 is able to circulate via a so-called penetrating line 110 connected to a peripheral scheduling station 6 that constitutes a rear base, where the goods to be transported are packed and scheduled as a function of their destination. Thus the goods intended to pass in transit through the same exchange station 4 of the loop 7 to reach their final destination are packed in the same container 3, advantageously at the scheduling station. The shuttles may be loaded at the scheduling station 6 in an order that is a function of the destination of the goods loaded onto each of these shuttles. Thus the station 6 can handle the management of a major portion of the flow of goods that is injected into the loop and can enable limitation of the flow of goods loaded onto the shuttles from the exchange stations 4 situated on the loop.

The line 110 may be bidirectional and produced in the form of a tunnel with two tracks or two parallel or non-parallel micro-tunnels.

At the surface, the exchange stations may include an area for storing the containers 3 pending sending thereof to a loading or unloading dock where they can be installed on electric vehicles for example.

There has been represented in FIGS. 6 and 7 an example of a container 3 according to one aspect of the invention.

That container 3 includes a fork-liftable base 200 and lateral walls 201, a rear wall 202 and a top wall 203. It is provided at the front with a closure means that may be of any type and preferably takes the form of a bi-fold door 204, each door including two panels 205 that can be folded one against the other. The panels 205 are articulated to one another and articulated to the lateral walls of the container 3.

Thus when the door 204 is open it provides totally free access to the interior volume of the container. When the panels 205 are folded against one another, as shown in FIG. 8, the overall size of the doors is reduced and the containers may be disposed close to one another, to minimize their footprint.

The fork-liftable base 200 has passages 210 for inserting the forks F of a pallet truck passing through it from front to rear and other passages 211 passing through it from left to right.

The width a₁ of the passages 210 is preferably between 20 and 50 cm inclusive, in particular between 29 and 50 cm inclusive, and that a₂ of the passages 211 between 20 and 25 cm inclusive. The width b₁ of the blocks outside the passages 210 is preferably between 10 and 20 cm inclusive and that b₂ of the central block present between the passages 210 is preferably between 10 and 18 cm inclusive. The passages 211 are preferably at a distance c₁ from the edge of the container between 8 and 15 cm inclusive, and the distance c₂ between the passages 211 is preferably between 10 and 18 cm inclusive. The passages formed on the shorter sides of the base of the container are preferably narrower than those produced on the longer sides, so as to reduce the risk of incorrect centering of the forks used to lift the container.

The passages 211 may be open at the bottom or not. The same applies to the passages 210. In FIGS. 9 and 10 the passages 210 are closed at the bottom by a wall 214 while the passages 211 are open at the bottom.

The base 200 may be made of metal or a synthetic, in particular thermoplastic, material, possibly a composite or fiber-reinforced thermoplastic material. The base 200 may include a metal framework onto which a thermoplastic material is overmolded.

The lateral, rear and top walls of the container may be made of metal or synthetic, in particular composite, material. The container may include a metal frame onto which a thermoplastic material is overmolded to form said walls.

The container preferably includes lateral, rear and top walls that are made of metal, in particular of corrugated sheet metal for greater stiffness. These walls may be assembled to a metal frame that is preferably strong enough to allow stacking of the containers.

As shown in FIGS. 11 to 13, the container 3 preferably includes means 220 for centering a pallet inside the container resting on the base 200.

In the example considered, those centering means include a ramp that extends over the perimeter of the base 200 inside the container and has two openings 222 at the front for the passage of the forks F of the pallet truck, as shown in FIG. 12.

There has been schematically represented in FIGS. 11 to 13 a pallet P placed on the base 200. It is seen that the clearance j between the base of the ramp and the edge of the pallet is small, for example between 0.5 and 2 cm inclusive.

The height k of the ramp is for example between 1 and 20 cm inclusive. This height may be less than that of the pallet P.

The container 3 may be constructed so that it can be compartmentalized, as shown in FIGS. 14 to 16.

In this example the container 3 is made with ribbed lateral walls 201 onto which profiles 230 are fixed at various heights inside the container, for example at ⅓, ½ and ⅔ the height.

Each profile 230 preferably has a protrusion 231 that espouses the concavity of a rib and two flanges 232 that bear on the back of the adjacent ribs. The flanges 232 may be fixed by rivets 234 to the lateral wall 201 of the container 3.

Each profile 230 has a bearing surface 235 for a board 238 for compartmentalizing the container 3, as shown.

In the variant shown in FIGS. 17 to 20 the container 3 includes retractable supports 240 that can assume a first configuration, shown in FIG. 17, in which they are folded against the adjacent wall 201, and a second, deployed configuration, shown in FIGS. 18 to 20, in which they support the load.

Each support 240 may, as shown in FIG. 20, include a lug 241 that is articulated to a support 242 fixed to the adjacent wall 201, for example by riveting it thereto.

The lug 241 may have a shape adapted to bear on a flank of a rib of the metal sheet, as shown in FIG. 20, which distributes the forces over a larger area.

The lug 241 may be articulated on the support 242 in such a manner as to make it obligatory to raise the lug 241 before being able to tilt it. This guarantees stable retention in the retracted configuration.

When deployed, the supports 240 may serve to hold a pallet P, as shown in FIG. 18, or to hold boards 238 each defining the floor of a compartment, as shown in FIG. 19.

The possibility of placing pallets at different heights provides additional flexibility by enabling use of the same single container with a plurality of pallets, which is of interest if the goods conditioned on the pallet are of low height.

When the supports 240 are retracted, they do not interfere with the goods M carried by the pallet P, as shown in FIG. 17.

Various examples of containers 3 suitable for transporting fresh or refrigerated goods will now be described with reference to FIGS. 21 to 28.

In the example from FIGS. 21 and 22 the container 3 receives a fork-liftable thermally insulating material box 250. A front panel 251 made of the same material may be mounted on the box 250, as shown in FIG. 22.

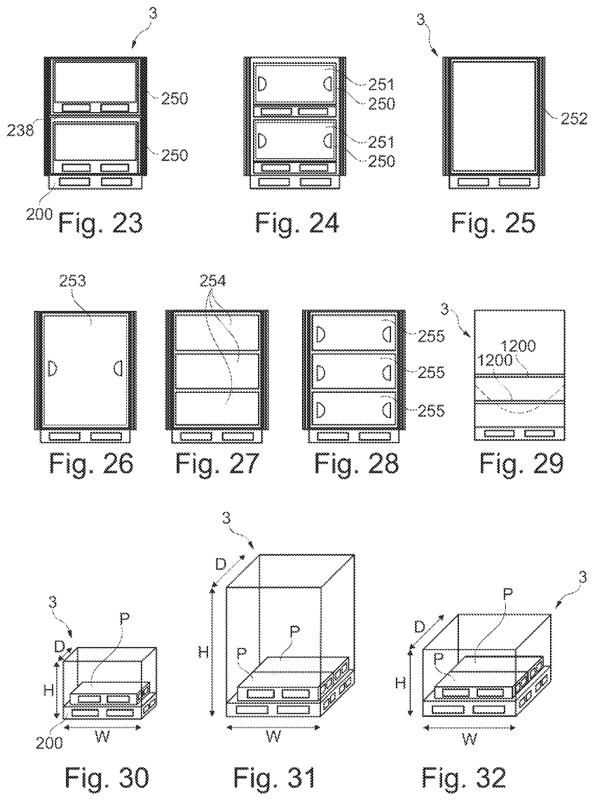

FIGS. 23 and 24 represent a variant that differs from the example from FIGS. 21 and 22 by the fact that the container 3 has two stacked compartments, each receiving a fork-liftable box 250. Each of these boxes 250 may be closed before the container 3 is closed by a corresponding individual closure panel 251.

In the variant from FIGS. 25 and 26, the container 3 receives an isothermal box 252 closed at the front by a front panel 253 positioned before closing the container 3.

The box 252 is not a fork-liftable box but can be replaced if damaged.

The variant from FIGS. 27 and 28 differs from that from FIGS. 25 and 26 by the fact that the box 252 has multiple compartments 254 each provided with an individual closure panel 255.

The container 3 preferably has a width W between 125 cm and 135 cm inclusive, a depth D between 85 cm and 130 cm inclusive, and a height H between 180 cm and 240 cm inclusive. A container of this kind is referred to as a single container because it is intended to receive one standard pallet, for example with sides 80 cm by 120 cm.

In a variant the container is less high and has a height H between 85 and 90 cm inclusive for example, as shown in FIG. 30.

The container 3 may again be a double container, as shown in FIGS. 31 and 32, and have the same width W but a depth D between 170 and 250 cm inclusive, so as to receive two pallets P disposed side by side, for example two standard EUROPE pallets.

There has been represented in FIG. 33 a container 3 that incorporates a bag 280 for the bulk return of packaging.

This bag 280 is for example open at the top and suspended from slides 281 present under the top wall of the container 3.

The bag 280 may be folded against the rear wall of the container 3 when the latter receives goods on pallets.

Once those goods have been removed, the bag 280 may be deployed by causing its attachments to slide toward the front, as shown in FIG. 34.

As shown, the bag 280 may preferably be loaded from the front, thanks to a front panel 282 provided with a zip closure 283 for example.

Once the packaging E has been removed from the bag 280, the front panel 282 may be closed again and the bag 280 then folded against the rear wall of the container 3.

Thus the containers 3 can easily transport goods and return empty packaging.

There has been represented in FIG. 36 a container 3 in which is received a bin 300 suitable for collecting bulk waste.

The outside dimensions of the bin 300 are adapted to suit the interior volume of the container 3 and there is for example a gap of less than 15 cm from the lateral walls of the container 3, better less than 10 cm, even better less than 7 cm.

The bin 300 may be fork-liftable thanks to a base 301 including passages 301 for this purpose.

The bin 300 may include a loading opening at the front, possibly provided with a closure flap 303.

The container 3 may be left in a collection zone with the bin 300 inside it. When the latter is full, the container may be picked up and lowered by an exchange station 4 to the micro-tunnel, and then sent to a scheduling station 6 where it is unloaded.

FIG. 37 represents a variant embodiment of the bin 300 which differs from that shown in FIG. 36 by the fact that the bin 300 is provided with wheels 309 that enable it to be moved easily when removed from the container 3.

The bin 300 may be removed from the container 3. It may as shown in FIG. 37A include a pivoting lid 317 so as to be emptied into a truck thanks to lifting bars 308 that enable it to be upturned above the area of the truck provided for this purpose.

The container 3 according to the invention is preferably connected, that is to say able to communicate with an external computer system.

The container 3 may include an electronic circuit 320 adapted to transmit information to a server tasked with tracking the circulation of the containers 3.

This electronic circuit 320 may be disposed in the base 200.

The container 3 may include one or more sensors 321 that provide the electronic circuit 320 with information for example on the temperature inside the container 3, the relative humidity, opening of the container 3, its position, its movements.

This data may be recorded locally and transmitted to the server tasked with tracking either periodically or upon passage in the vicinity of a reader terminal.

The container 3 may also be adapted where appropriate to read an electronic tag 400 carried by the pallet P disposed inside the container 3.

That tag 400 may transmit to the container 3 an identifier of the pallet P.

The container 3 may communicate with the tracking server and receive from the latter information concerning the destination of the pallet for example.

Once arrived at its destination, the container 3 may advise the tracking server of the arrival of the pallet P.

Data may be transmitted from the container 3 in various ways, for example via an IoT transmission network such as SIGFOX or LORA.

The electronic device equipping the container may be programmed to provide various functions, in particular some or all of the following functions:

tracking the position of the container, by receiving location information from a geolocation chip equipping the container, of GPS type for example, and/or by receiving information from a terminal near which the container passes, for example on arriving at an exchange station,

recording the path of the container and/or transmitting that path to a server tasked with tracking the containers,

storing the data from at least one temperature, relative humidity, acceleration, liquid and/or pressure sensor and/or transmitting data to a server tasked with tracking the containers,

where appropriate signaling when the data measured by a sensor departs from a predefined range, for example excessive temperature or excessive acceleration linked for example to dropping the container when handling it,

detecting opening of the container and/or signaling that opening to a server tasked with tracking the containers, so as to guarantee the traceability of the goods loaded in the container,

detecting loading of the container, for example with the aid of an optical sensor or a strain gauge, which can provide information on the weight of the goods and trigger an alarm in the event of overloading, or enable verification on the basis of measurement of the weight the consistency of the measurement with the expected weight, which can assist verifying that given goods have indeed been loaded into the container that is to receive them,

controlling opening of the container if the door is provided with a remotely controllable lock,

controlling opening of one or more racks of the container if those racks are provided with remotely controllable doors,

enabling communication with a cellphone or other appropriate terminal to control the opening of one or more doors, that communication being for example of WIFI, BLUETOOTH, NFC, WAN or LAN type,

reading at least one RFID chip carried by a pallet or goods present on the pallet or carried by an element fixed in the container, such as for example a locker module, one or more isothermal boxes or a bin,

exchanging data with RFID chips carried by goods on the pallet to inventory the latter and for example to verify that only the goods to be taken off at the level of an exchange station or a collection point have been,

storing information on the provenance of the load and/or its destination,

transmitting this information to a shuttle or to a surface vehicle on which the container is placed and/or to a robotic system tasked with loading and/or unloading the shuttles or to an operator tasked with taking off the goods,

charging a battery equipping the container,

controlling the locking means on a shuttle or surface vehicle, in particular unlocking a container when the latter arrives at its destination.

Examples of use of a container 3 as a locker will now be described with reference to FIGS. 39 to 58.

In these examples, the container 3 includes at least one closed compartment the opening of which can be triggered by a person authorized to recover the contents of that compartment.

The container 3 may be warehoused in an area reserved for that purpose. Persons are advised of the arrival of the container with their package inside it and trigger opening of the corresponding compartment for example using a code entered with their cellphone.

The compartment containing the package may be equipped with indicator lights advising the person of its location, as shown in FIG. 58.

The distribution system according to the invention preferably includes containers 3 having a common main part, of the same interior volume for all the containers, having the same base, lateral, top and rear walls. On the basis of this main part common to all the containers, it is possible to introduce variations according to the type of goods to be transported or the intended application.

It is therefore of interest to disposed in the common main part a locker module 500 including a plurality of independent racks closed by as many doors 501, each unlocked electronically by entering a specific code with the aid of a cellphone for example.

This module 500 may be fixed to the lateral walls 201 of the container 3, as shown in FIG. 39, or to the base 200 of the container 3, as shown in FIG. 40.

The racks of the module 500 may be different sizes, so as to accommodate a great variety of goods.

In FIGS. 41 to 53 there have been represented various arrangements of the container 3 when the latter is produced with a plurality of compartments each having a specific opening.

If necessary a plurality of containers 3 can be stacked, as shown in FIGS. 54 to 57.

In FIG. 59 there has been represented very schematically a shuttle 17 adapted to circulate in the micro-tunnel and containers 3 in place on the latter.

The base 200 of the containers 3 is adapted to be locked in position on this shuttle 17.

To provide this locking the shuttle or the vehicle may be equipped with at least one lock 550 that is engaged onto the base to immobilize it, as shown in FIG. 60.

This lock 550 may include a hook that hooks onto a relief of the base 200, for example a relief 552 disposed in a passage to receive a pallet truck fork.

To unlock the container 3 the lock is moved for example thanks to an electromagnetic or pneumatic actuator, as shown in FIG. 61.

Again the container may be equipped with a lock 560 adapted to hook automatically onto a corresponding relief 561 of the shuttle 17 or of the surface vehicle.

To unlock the container 3 this lock is moved, for example by an actuator present on the shuttle 17 or the surface vehicle, or forming part of the base 200 of the container 3.

In the variant from FIGS. 68 to 72, the platform 1000 intended to receive the container, in particular on the shuttle 17, includes a locking mechanism 900 actuated automatically by putting the base of the container 3 in position.

The base 200 of the container may be provided with an attachment bar 910 as shown.

The mechanism 900 includes a support element 911 mobile relative to the platform 1000 that is pushed by the base 200 on putting the container into position, as shown in FIGS. 68 to 70.

This element 911 may include a hook 912 that engages over a corresponding relief 913 produced on the base 200, for example on a profile 913 intended to receive a pallet truck fork, that relief being in the form of a hole 914 in this profile. Engagement of the hook 912 in the hole 914 and the profile 913 abutting against the support element 911 participate in retaining the container 3 on the platform.

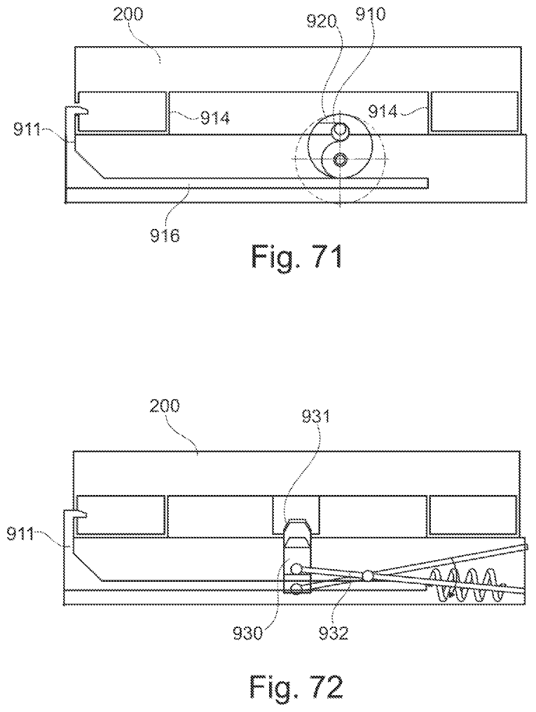

The support element 911 is connected by a linkage 916 to a pivoting hook 920. A rack may be provided on the linkage 916, cooperating with teeth present on the hook 920 to transform the backward movement of the element 911 when fitting the base 200 into position into a rotation of the hook 920. At the end of its rotation the hook 920 is engaged over the bar 910, as shown in FIG. 71, which also contributes to the retention of the container 3 on the platform 1000.

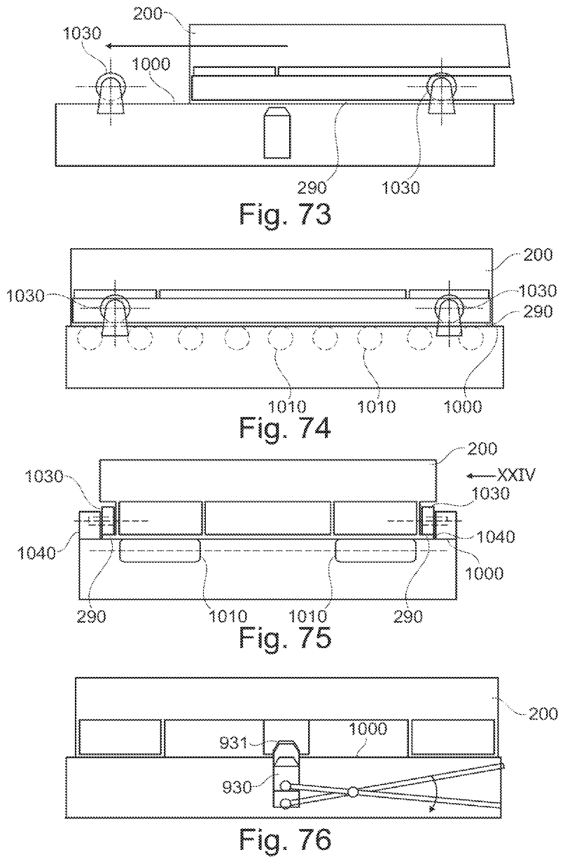

As shown in FIG. 72, a locking pin 930 mobile vertically relative to the platform and a corresponding housing 931 on the base 200 of the container 3 may be provided to render secure the immobilization of the latter.

The pin 930 is for example actuated by a pivoting arm 932 which may be moved by any appropriate actuator.

A return spring 933 is provided to return the hook 920 to the open position when the container 3 is unloaded. To this end, the pin 930 is retracted into the platform 1000 and the container 3 is moved back relative to the support element 911. During this backward movement, the spring 933 causes the support element 911 to follow the container 3 and the hook 920 to release the bar 910.

A slight clearance may be provided, if necessary, to enable the container 3 to be lifted slightly by the forks of a pallet truck with the hook 920 covering the bar 910 so as to move it back. Alternatively, the platform 1000 is provided with rollers on which the base 200 rests so that retraction of the pin 930 causes automatic backward movement of the container 3 because of the return effect of the spring 933, the container 3 rolling on the rollers during this backward movement.

In the variant embodiment from FIGS. 73 to 76 the platform 1000 includes rollers 1010 on which the container 3 is able to roll.

The base 200 of the container is produced with lateral flanges 290 and the platform 1000 is provided with rollers 1030 under which the flanges 290 of the base 290 engage. The platform 1000 may include four rollers 1030 so that the container 3 is therefore retained vertically on the platform 1000 and immobilized in the direction perpendicular to its insertion by abutments 1040 on which the rollers 1030 may be mounted.

A locking pin mechanism 930 as described hereinabove provides complete immobilization of the base 200.

To remove the container 3 from the platform 1000 the pin is retracted and the base 200 is moved in the opposite direction relative to the platform 1000.

An example of loading at least one container 13 onto a surface vehicle 600 will now be described with reference to FIGS. 65A to 65C.

The containers 3 are for example loaded in groups of four, six or eight onto the same vehicle.

The containers 3 may be conveyed from the elevator of the exchange station to a vehicle loading dock by any type of conveyor, for example by roller conveyors.

The latter may be situated at the same height as the loading platform of the vehicle, as shown.

The latter may be a low-loader autonomous vehicle such that its total height T, as shown in FIG. 66, is less than 2 m80, to enable it to circulate in underground carparks. The platform 1000 intended to receive the containers may be situated at a height M above the ground less than or equal to 40 cm.

The vehicle may be provided at the rear with a retractable curtain 606 lowered during loading of the containers 3 and raised during transportation thereof.

The containers 3 are preferably unloaded at their destination using an unloading dock at the same height as the platform of the vehicle. The container 3 may also be provided with lifting lugs, in which lifting hooks can be engaged.

When the container 3 is produced in the form of a locker, the container 3 may remain on the vehicle; in this case, the intended recipient of the package is advised of the arrival of their package by a message on their telephone, for example, and can go to find it at a parking place of the vehicle.

The container 3 according to the invention being fork-liftable, it may be moved using a pallet truck.

In the absence of a pallet truck the container 3 may be placed on a trolley 700 as shown in FIG. 67, including wheels 701 and a tray 702 matching the dimensions of the base 200, with a rim 703 at the periphery to hold the container 3 centered on the tray 702.

There has been shown in FIG. 77 an example of a shuttle 17 in a micro-tunnel 2 of which only a portion of its wall 2002 is represented.

The example of a shuttle 17 represented includes a chassis 11000 including two longitudinal members 11001 and 11002 and a plurality of crossmembers that extend transversely to the longitudinal members 11001 and 11002, in particular a front crossmember 11003 and an adjacent crossmember 11005, a rear crossmember 11004 and an adjacent crossmember 11006 and at least one intermediate crossmember 11007, the longitudinal members 11001 and 11002 and the front crossmember 11003 and the rear crossmember 11004 forming a rectangular peripheral frame.

In the example considered, the chassis 11000 is sized to receive four containers 3 disposed in two rows of two containers 3.

As shown in FIG. 77 the shuttle 17 includes two spaces 2012 to receive one or more containers 3.

The shuttle 17 is open at the sides and includes a front barrier 2003 and a rear barrier 2004 as well as an intermediate barrier 2005, all fixed to the chassis 11000, the intermediate barrier 2005 providing the partition between the two spaces 2012.

The front barrier 2003 and the rear barrier 2004 are retained by a support structure 2040 with legs 2030 that rest on the peripheral frame of the chassis 11000.

Each barrier may include a bottom guide slide 2050 and a top guide slide 2060, the top slide 2060 being situated substantially at the level of the upper half of the containers 3 when the latter are in place in the receiving space 2012.

The space between the slides of two adjacent barriers may be slightly greater than the length of a container 3 so as to enable it to slide between them when loading or unloading the shuttle.

The guide slides may be slightly inclined at their ends so as to define insertion ramps 20170 facilitating engagement of the containers in the receiving space 2012.

In the example considered, each space 2012 is able to receive two containers 3 disposed side by side, only one of which is represented. Each space 2012 includes, in particular over all of its surface, transport rollers 2008 on which the fork-liftable base 200 of the container 3 rests. These transport rollers 2008 enable each container 3 to be rolled, in particular when it is placed in and/or removed from the shuttle 17. The transport rollers 2008 are oriented in the longitudinal direction of the shuttle 17. The length of the transport rollers 2008 is equal to or slightly greater than the length of a container 3 (here the length of a container is its dimension in the longitudinal direction of the shuttle).

The shuttle 17 includes a mechanism for coupling it to a drive cable 42 enabling it to be pulled by the cable 42, which runs between rails 40, parallel to the latter. A guide structure 2001 of the cable 42 is mounted on a support 2000 shared with the rails 40.

The cable 42 forms a loop, with an outgoing section 42b and a return section 42a. As shown in FIG. 78, the guide structure 2001 may include a bottom roller 2001a on which the return section 42a of the cable 42 rests and an upper roller 2001b on which the outgoing section 42b of the cable 42 rests, with which the shuttles 17 can come to be engaged to be driven on the rails 40, the two rollers 2001a and 2001b preferably having parallel rotation axes spaced sufficiently close together in the vertical direction for the return section 42a to come into contact both with the upper rollers 2001b and lower rollers 2001a.

The support 2000 may be of arcuate shape, concentric with the wall 2002 of the micro-tunnel 2 and may bear directly on the latter, as shown in FIGS. 77 and 78.

The peripheral frame of the chassis 11000 of the shuttle 17 defines housings between, on the one hand, the front crossmember 11003 and the adjacent crossmember 11005, and, on the other hand, the rear crossmember 11004 and the adjacent crossmember 11006, respectively receiving a front axle assembly 2006 and a rear axle assembly 2007.

The front axle assembly 2006 and the rear axle assembly 2007 each include for example, as shown, six wheels comprising two support wheels 2011 that come to bear on the rails and support the weight of the shuttle 17 and four lateral guide wheels 2010, as shown in FIG. 79. The support wheels 2011 rotate about a horizontal axis and the lateral guide wheels 2010 rotate about a vertical axis.

Each of the axle assemblies includes a main arm 2080 and two lateral arches 2090 connected to each of the ends of the main arm 2080.

As shown in FIG. 79, the main arm 2080 is divided at each of its ends into two branches 2081 the ends of which are fixed to the lateral arches 2090.

Each lateral arch 2090 is fixed at each of its ends to the chassis 11000 at the level of the front crossmember 11003 and the adjacent crossmember 11005 or at the level of the rear crossmember 11004 and the adjacent crossmember 11006.

A yoke 2100 is connected in an articulated manner to the middle of each lateral arch 2090 so as to be able to pivot about a vertical axis. A support wheel 2011 is mounted on this yoke 2100.

A support structure 2110 is connected in an articulated manner to the middle of each lateral arch 2090 so as to be able to pivot about a vertical axis. Two guide wheels 2010 are mounted on this support structure 2110.

As shown in FIG. 79, the front axle assembly 2006 includes a central arch 2120 that is fixed to the middle of the main arm 2080, this central arch 2120 carrying the mechanism for coupling it to the cable 42.

The mechanism for coupling it to the cable 42 includes a clamp 2130 configured to be coupled to and uncoupled from the cable 42 and a structure mobile relative to the fixed central arch 2120 to which it is fixed.

This mobile structure includes two uprights 2140 each of which carries at least one actuator roller 2150. The clamp 1230 includes at least two jaws connected by a transmission mechanism on the one hand to the fixed central arch 2120 and on the other hand to the mobile structure.

The transmission mechanism is arranged so that movement of the mobile structure relative to the fixed central arch 2120 is accompanied by clamping of the jaws onto the cable 42 or releasing them from the cable 42, depending on the upward or downward movement of the mobile structure.

The mechanism may include at least one elastic member 2170 for returning the jaws of the clamp 1230 to the clamping position. This elastic return member 2170 may be a coil spring, oriented vertically, the lower end of which is fixed, as shown in FIG. 79.

For example, actuation of the clamp 2130 is achieved by pressing the two actuator rollers 2150 simultaneously.

The rails 40 extend in a longitudinal direction of the micro-tunnel 2. As shown in FIG. 78, each of the rails 40 has an I-shape cross section with an upper horizontal bearing face, a lower horizontal bearing face and a vertical wall connecting the upper and lower bearing faces. The lower bearing faces bear on the support 2000 and the support wheels 2011 roll on the upper horizontal bearing faces. The guide wheels 2010 bear on an internal face of the vertical wall.

There has been shown in FIGS. 80 and 81 an example of a shuttle 17 including a chassis 11000 sized to receive six containers 3 disposed in two rows of three containers 3, a row extending in the longitudinal direction of the shuttle 17. The shuttle 17 includes three receiving spaces 2012, each space 2012 being able to receive two containers 3 disposed side by side. The shuttle 17 includes a front barrier 2003 and a rear bather 2004 together with two intermediate barriers 2005 disposed between the spaces 2012.

Each shuttle 17 may include a mechanism for locking a container 3 onto the shuttle 17, as shown in FIGS. 82 to 87.

This locking mechanism may be activated and deactivated automatically, respectively by putting into place and removing the base 200 of the container or containers 3.

A locking mechanism of this kind is associated with each receiving space 2012 of the shuttle 17.

Two adjacent spaces 2012 may have locking mechanisms having elements in common.

The locking mechanism may include for each space 2012 of the shuttle 17 two opposite rows of locking elements 2020. Each row may include two or four locking elements 2020. The locking elements 2020 of two opposite rows may be arranged in a quincunx, as shown in FIG. 86.

Each locking element 2020, mobile relative to the platform 1000, may include at its upper end a hook 2030 configured to come into contact with the base 200 of the container 3 in such a manner as to lock the latter to the receiving space 2012 concerned. For example, this hook 2030 engages over a corresponding relief produced on the base 200, for example a notch (not represented). The engagement of the hook 2030 in the notch in the base 200 participates in retaining the container 3 on the platform 1000.

Each locking element 2020 may be mobile in rotation relative to a transverse axis of the platform 1000.

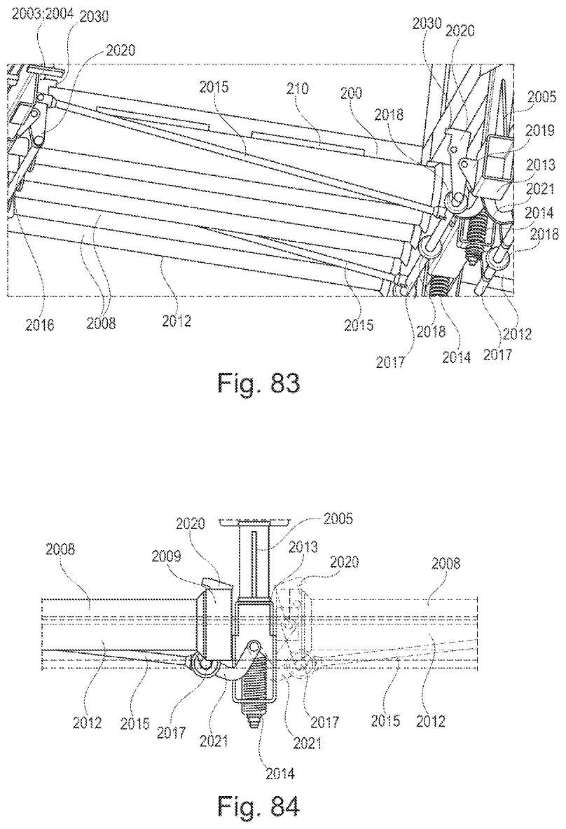

Each locking element 2020 is articulated at approximately mid-height on a support means 2019 fixed to the chassis 11000 of the shuttle 17. In the example considered in FIG. 83 each locking element 2020 is articulated on a yoke 2019 fixed to an intermediate crossmember 11007 of the chassis 11000.

The locking elements 2020 of the same row are articulated at their lower ends on a shaft 2017, that shaft 2017 being horizontal and oriented in the transverse direction of the shuttle 17.

Of the two opposite rows of locking elements 2020 of a receiving space 2012, one row includes actuator rollers 2018 carried by the shaft 2017 and the distance between these rollers 2018 may be identical.

In the example considered, the row of locking elements 2020 positioned in the vicinity of the intermediate barrier 2005 includes actuator rollers 2018 carried by the shaft 2017, in particular three rollers 2018, and the row of locking elements 2020 positioned in the vicinity of the front barrier 2003 or the rear barrier 2004 does not include rollers 2018 carried by the shaft 2016.

The movement of the shaft 2017 that carries the rollers 2018 is transmitted to the locking elements 2020 of the opposite row by way of linkages 2015 that are articulated at their ends to the shaft 2017 and to the locking elements 2020 of the opposite row.

### Unlocking the Containers

The rollers 2018 are actuated by one or more actuators (not represented) so as to push the rollers 2018 in the direction away from the intermediate barrier 2005.

The actuator or actuators may be outside the shuttle 17, for example at the level of an exchange or scheduling station.

The rollers 2018 being fixed to the shaft 2017, actuation thereof enables the shaft 2017 to be pushed in the direction away from the intermediate barrier 2005, which enables driving in rotation of the locking elements 2020 that are connected to the shaft 2017 so as to move those locking elements 2020 to the unlocked position, as shown in FIGS. 82 and 84.

The movement of the shaft 2017 in the direction away from the intermediate barrier 2005 also enables actuation of a mechanism with links 2021 including two links 2021 connected at one of their ends to the adjacent shafts 2017 and at the other of their ends to at least one return member 2014, in particular a coil spring, oriented along a vertical axis.

These springs 2014 may be situated in the vicinity of the intermediate barriers 2005 and in part accommodated inside the latter.

Two adjacent spaces 2012 of the platform 1000 may share the springs 2014 of their locking mechanism.

The actuation of the links 2021 enables compression of the springs 2014, as shown in FIGS. 82 and 84.

The rods 2015 enable the movement of a shaft 2017 to be transmitted to the locking elements 2020 of the opposite row so as to move those locking elements 2020 to the unlocked position, as shown in FIG. 82.

Thus the locking elements 2020 of the two opposite rows go to the unlocked position, which enables a container 3 to be unlocked from the platform 1000, in particular when the latter arrives at its destination.

As shown in FIGS. 82, 83, 86 and 87 the locking mechanism for a space 2012 of the platform 1000 may include two rods 2015.

A single actuator (not represented) can enable unlocking of the locking elements 2020 of all of the receiving spaces 2012 of the shuttle 17.

Alternatively, the containers 3 are not unlocked by actuating the rollers 2018 but by actuating the linkage mechanism. For example an actuator comes to compress the return member 2014 differently so as to unlock the locking elements 2020.

### Locking the Containers

The return force of the spring 2014 enables the links 2021 to pull the shaft 2017 toward the intermediate barrier 2005, which enables driving in rotation of the locking elements 2020 that are connected to the shaft 2017 so as to move those locking elements 2020 to the locked position, as shown in FIGS. 83, 85 and 86.

The rods 2015 transmit the movements of the shaft 2017, positioned in the vicinity of the intermediate barrier 2005, to the locking elements 2020, positioned in the vicinity of the front barrier 2003 or the rear barrier 2004, so as to move those locking elements 2020 to the locked position, as shown in FIG. 83.

The locking elements 2020 of the two opposite rows are therefore in the locked position, that is to say in contact with the base 200 of the container 3, which enables locking of the container 3 onto the platform 1000, in particular when it is in its final position on the platform 1000.

As shown in FIGS. 77, 80, 81 and 84 to 87, each space 2012 of the platform 1000 may include one or more friction wheels 2009 the rotation of which drives one or more transport rollers 2008 of the receiving space 2012 concerned via a transmission chain (not represented). This enables loading and unloading of a container 3 to be facilitated.

The friction wheels 2009 are positioned at the ends of the transport rollers 2008, preferably in the vicinity of the intermediate barriers 2005 of the platform 1000. In the example considered, each receiving space 2012 includes two friction wheels 2009, the latter being situated in particular at the level of the first and last transport rollers 2008 of the space 2012 concerned.

Each of the friction wheels 2009 includes a friction band enabling it to be driven in rotation by friction. For example, these friction wheels 2009 are coupled to drive wheels of an exchange or scheduling station. These drive wheels are rotated by drive means and come to bear on the friction wheels 2009 to drive them in rotation. Alternatively, the rollers are motorized by motor means present on the shuttle 17.

Of course, the invention is not limited to the example shown.

Different particular embodiment features described separately may be combined.

The container may be provided with closure means other than those that have just been described. For example, the container 3 has no door at the front or by way of closures includes one or more removable bars 1200 as shown in FIG. 29, or even a simple chain as shown in dashed line in FIG. 29.

The barriers may be constructed differently and for example in the form of solid or perforated, single or multiple partitions. Those partitions may be provided with slides or not.

Where appropriate the slides may be provided with sliding strips of a low coefficient of friction material. The axle assemblies of the shuttle need not include shock absorbers.

Alternatively, shock absorbers are provided to attenuate the vibrations linked to rolling.

1. A container, the container being fork-liftable, and having a base with inside dimensions adapted to receive only one or at most two pallets.

2. The container as claimed in claim 1, including:
at least one first attachment means intended to cooperate with at least one second attachment means present on a platform intended to receive the container to enable its immobilization on said platform.

3. The container as claimed in claim 2, the first attachment means and the second attachment means being configured to engage automatically when the container is placed on the platform.

4. The container as claimed in claim 3, the first attachment means including at least one hook carried by the container adapted to hook onto the second attachment means.

5. The container as claimed in claim 2, the first attachment means including at least one relief onto which can be hooked a hook of the second attachment means.

6. The container as claimed in claim 3, the second attachment means including a mechanism transforming a push exerted on a support member when placing the container on the platform into a movement of a hook coming to be engaged on the first attachment means.

7. The container as claimed in claim 3, the first attachment means including two lateral flanges and the second attachment means rollers under which the lateral flanges are engaged when placing the container on the platform.

8. The container as claimed in claim 3, the second attachment means including a vertically mobile lock and the first attachment means including a housing to receive that lock.

9. The container as claimed in claim 1, including a base and means for centering a pallet, that centering means having openings for the passage of the forks of a pallet truck.

10. The container as claimed in claim 1, including:
a base,
lateral walls,
retractable supports or fixed to the lateral walls, enabling at least one pallet to be disposed at a height in the container or inserts, boxes or drawers to be disposed to enable compartmentalization of the container.

11. The container as claimed in claim 1, including:
a bag disposed in the container so as to assume a folded state during the transport of goods in the container and a deployed state enabling the transportation of empty packaging.

12. The container as claimed in claim 1, including:
lateral walls, a rear wall, and a top wall,
a fork liftable locker module disposed inside the container, that locker module including at least one rack provided with a door that can be unlocked remotely.

13. The container as claimed in claim 1, including a double door, each door being formed by at least two articulated panels that can be folded one against another.

14. The container as claimed in claim 1, including an opening with no door across which may be mounted at least one bar or one chain.

15. The container as claimed in claim 1, including at least one box made of a thermally insulating material, the box being disposed inside the container.

16. The container as claimed in claim 1, having an interior section adapted to receive only one pallet.

17. The container as claimed in claim 16, having an interior section X+dx by Y+dy, where X and Y designate the dimensions of the sides of the pallet received in the container, with dx between 1 and 20 cm inclusive and/or dy between 1 and 20 cm inclusive.

18. The container as claimed in claim 1, having an interior section adapted to receive only two pallets disposed side by side.

19. The container as claimed in claim 1, the height of the container being between 100 and 240 cm inclusive.

20. The container as claimed in claim 1, having no refrigeration unit.

21. The container as claimed in claim 1, being fork-liftable from front to rear and/or laterally.

22. A combination including a container as defined in claim 1 and goods on pallet(s) disposed inside the container.

23. A combination including a container as defined in claim 1 and a fork-liftable bin.

24. A combination including:
at least one container as claimed in claim 2, including said first attachment means,
a shuttle or a surface vehicle including said second attachment means.

25. A combination including:
a plurality of containers each as claimed in claim 1, and
a set of accessories enabling modulation of the occupancy of these containers as a function of various applications and of the nature of the goods, chosen from inserts enabling them to be compartmentalized, isothermal boxes, bins and/or locker modules.

26. A system for distributing goods in urban areas, including:
at least one micro-tunnel forming at least one transport loop,
shuttles circulating unidirectionally in said at least one transport loop,
a set of containers as defined in claim 1,
a plurality of stations for exchange with the surface, enabling the containers to be raised.

27. The system as claimed in claim 26, the micro-tunnel including sections assembled one after the other, between 2.5 and 3.5 m inclusive long, and having a wall thickness between 150 and 500 mm inclusive.

28. The system as claimed in claim 26, the micro-tunnel being buried at a depth greater than or equal to 20 m.

29. The system as claimed in claim 26, the shuttles being pulled by at least one cable in the micro-tunnel.

30. The system as claimed in claim 26, including at least one station for scheduling goods to be injected into said at least one loop and to be distributed via exchange stations situated on said at least one loop.

31. A method of distributing goods in urban areas with the aid of a system as defined in claim 26, including the steps consisting in:
a) bringing goods to a scheduling station by surface transport means,
b) lowering containers containing the goods to the micro-tunnel,
c) circulating the containers unidirectionally in said at least one transport loop to a station for exchange with the surface,
d) raising the containers to the surface.

32. The method as claimed in claim 31, further including the step consisting in:
loading at least one container onto a low-loader vehicle the total height of which when the vehicle is loaded with the container is less than 2 m80.

33. The method as claimed in claim 31, the container being brought to a point for recovery of the goods, the container including at least one rack equipped with a door the unlocking of which may be remote controlled or accommodating a locker module including at least one rack equipped with a door which may be unlocked by remote control.

34. The method as claimed in claim 31, including the steps consisting in:
disposing the container on a platform of a shuttle,
locking the container in position with the aid of the first and second attachment means,
transporting the container via said at least one transport loop to a station for exchange with the surface,
acting on at least one of the first and second attachment means and unlocking the container,
removing the container from the transport shuttle,
conveying the container to a surface vehicle,
disposing the container on a platform of the surface vehicle,
locking the container in position with the aid of the first and second attachment means.

35. The method as claimed in claim 34, including the steps consisting in:
a) transporting the container in urban areas on the surface vehicle,
b) taking goods out of the container without unloading it from the surface vehicle or unlocking the container from the platform,
c) repeating steps a) and b) or returning the empty container to a surface station.

36. The method as claimed in claim 34, in which the container must be delivered to a certain destination, and in which the container is unlocked automatically from the platform on arrival of the vehicle at its destination.

37. The method as claimed in claim 31, in which an electronic circuit on the container exchanges information with the surface vehicle.

38. The method as claimed in claim 31, the container including:
a bag disposed in the container so as to assume a folded state during the transportation of goods in the container and a deployed state enabling the transportation of empty packaging,
the method including the step consisting in taking out the goods present in the container and, once the container is emptied of its goods, deploying the bag, loading the bag with empty packaging, then returning the container loaded with packaging to an exchange station and transporting the container with the aid of said at least one transport loop to a station where it is recovered, emptied of packaging and reused.

39-60. (canceled)

61. The container as claimed in claim 1, being suitable for a system for distributing goods in urban areas, that system including:
at least one micro-tunnel forming at least one transport loop,
shuttles circulating in the micro-tunnel,
a plurality of stations for exchange with the surface, enabling raising of the goods.

62. The container as claimed in claim 39, a greatest inside dimension of the micro-tunnel in cross section being between 1.5 m and 4 m inclusive.

63. The container as claimed in claim 39, the inside diameter of the micro-tunnel being between 1.5 m and 4 m inclusive.

64. The container as claimed in claim 2, the platform being a platform either of a shuttle or of a surface vehicle.

65. The container as claimed in claim 5, the relief being formed by or in a passage intended to receive a fork of a pallet truck.

66. The container as claimed in claim 6, the movement being a movement of rotation.

67. The container as claimed in claim 6, the first attachment means including a bar on which said hook is engaged at the end of its movement.

68. The container as claimed in claim 10, the lateral walls being corrugated vertically or horizontally.

69. The container as claimed in claim 11, the bag being suspended from slides disposed inside the container.

70. The container as claimed in claim 11, the bag having a front panel that can be opened and closed with the aid of a closure device.

71. The container as claimed in claim 12, the module including a plurality of racks each equipped with a door that can be unlocked by remote control.

72. The container as claimed in claim 15, the box being removable.

73. The container as claimed in claim 15, the box having dimensions adapted to be inserted without play or with slight lateral play inside the container.

74. The container as claimed in claim 15, the box being fork-liftable.

75. The container as claimed in claim 17, the pallet being chosen from standard EUROPE pallets.

76. The container as claimed in claim 17, the pallet being chosen from standard EUROPE pallets of EUR, EUR 1, EUR 2, EUR 3 or ISO type as defined in the standard ISO 6780.

77. The container as claimed in claim 17, the pallet being a EUROPE pallet with sides 80 cm by 120 cm.

78. The container as claimed in claim 18, having an interior section of 2X+dx by Y+dy, or X+dx by 2Y+dy, where X and Y designate the dimensions of the sides of the pallets received in the container, with dx between 1 and 20 cm inclusive and/or dy between 1 and 20 cm inclusive.

79. The container as claimed in claim 18, the pallets being chosen from standard EUROPE pallets.

80. The container as claimed in claim 18, the pallets being chosen from standard EUROPE pallets of EUR, EUR 1, EUR 2, EUR 3 or ISO type as defined in the standard ISO 6780.

81. The container as claimed in claim 18, the pallets being EUROPE pallets with sides 80 cm by 120 cm.

82. The container as claimed in claim 22, the goods being disposed on a single pallet inside the container.

83. The container as claimed in claim 23, the fork-liftable bin including a pivoting lid.

84. The container as claimed in claim 23, the fork-liftable bin including a front opening provided with a foldable flap.

85. The container as claimed in claim 23, the fork-liftable bin including lifting means enabling it to be tipped up to empty it.

86. The container as claimed in claim 25, each container having a size adapted to receive a single pallet.

87. The container as claimed in claim 28, the micro-tunnel being buried at a depth greater than or equal to 30 m.

88. The container as claimed in claim 28, the micro-tunnel being buried at a depth greater than or equal to 40 m.

89. The method as claimed in claim 33, the container being brought to a point for recovery of the goods by a surface transport vehicle.

90. The method as claimed in claim 33, the door can be unlocked by remote control with the aid of a cellphone.

91. The method as claimed in claim 34, the step consisting in disposing the container on a platform of a shuttle and/or the step consisting in removing the container from the transport shuttle and/or the step consisting in disposing the container on a platform of the surface vehicle being carried out automatically.

92. The method as claimed in claim 34, the step consisting in disposing the container on a platform of a shuttle and/or the step consisting in removing the container from the transport shuttle and/or the step consisting in disposing the container on a platform of the surface vehicle being carried out using the passages of the container provided to receive the forks of a pallet truck or by causing the container to circulate on rollers.

93. The method as claimed in claim 34, the step consisting in conveying the container to a surface vehicle being carried out using an elevator and one or more conveyors and/or autonomous pallet trucks.

94. The method as claimed in claim 37, in which the electronic circuit is an RFID chip.

95. The method as claimed in claim 37, in which the electronic circuit transmits to surface vehicle a destination of the goods, and/or enables the surface vehicle to identify the container automatically.

96. The method as claimed in claim 38, the bag being suspended from slides disposed inside the container.

97. The method as claimed in claim 38, the bag having a front panel that can be opened and closed with the aid of a closure device.

98. The method as claimed in claim 38, the empty packaging being the packaging of goods previously transported using the container or an identical container.
